(19) United States
(12) Patent Application Publication
(10) Pub. No.: US 2022/0351884 A1
(43) Pub. Date: Nov. 3, 2022

(54) SOFT MAGNETIC ALLOY AND MAGNETIC COMPONENT

(71) Applicant: TDK Corporation, Tokyo (JP)

(72) Inventors: Hajime AMANO, Tokyo (JP); Kazuhiro YOSHIDOME, Tokyo (JP); Kenji HORINO, Tokyo (JP); Hiroyuki MATSUMOTO, Tokyo (JP)

(73) Assignee: TDK Corporation, Tokyo (JP)

(21) Appl. No.: 17/763,865

(22) PCT Filed: Sep. 30, 2020
(86) PCT No.: PCT/JP2020/037278

§ 371 Date: Mar. 25, 2022

(30) Foreign Application Priority Data
Sep. 30, 2019 (JP) 2019-180942
Sep. 30, 2019 (JP) 2019-180946
Sep. 30, 2019 (JP) 2019-180947

(51) Int. Cl. H01F 1/153; C22C 45/02

(52) U.S. Cl. CPC H01F 1/153; C22C 45/02

(57) ABSTRACT

A soft magnetic alloy contains Fe and at least one of metalloid element. An amorphous material and a nanocrystal having a grain size of 5 to 30 nm are mixed. A coefficient of determination between an atomic concentration of Fe and an atomic concentration of the at least one of metalloid element is 0.700 or more.

### BACKGROUND OF THE INVENTION

The present invention relates to a soft magnetic alloy and a magnetic component.

Patent Document 1 discloses an Fe-based soft magnetic alloy in which nano-sized crystals including α-Fe as a main component and Si, B, and the like which are solid-dissolved are precipitated by heat-treating an amorphous alloy including Fe—Si—B as a basic component.

Patent Document 2 discloses a soft-magnetic alloy in which Fe-based nanocrystals are precipitated by heat-treating an alloy including Fe as a main component and Si. The soft magnetic alloy is composed of Fe-based nanocrystals and an amorphous material.

Non-Patent Document 1 discloses a soft magnetic alloy having a microstructure shown in FIG. 4 and FIG. 5 to be described later. Specifically, a soft magnetic alloy including an α-Fe phase 11, an amorphous phase 13, and a TaC phase (M-Z compound phase 15 to be described later) as illustrated in FIG. 4, and a soft magnetic alloy including the α-Fe compound phase 11 and the TaC phase (M-Z compound phase 15 to be described later) as illustrated in FIG. 5 are disclosed.
[Patent Document 1] JP 2713363 B2
[Patent Document 2] JP 6460276 B1
[Non-Patent Document 1] Materials Transactions, JIM, Vol. 36, No. 7 (1995), pp. 952 to 961

### BRIEF SUMMARY OF INVENTION

An object of the present invention is to provide a soft magnetic alloy having a high saturation magnetic flux density Bs and low coercivity He.

In order to achieve the above object, a soft magnetic alloy according to the present invention includes Fe and at least one of metalloid element; wherein

an amorphous material and a nanocrystal having a grain size of 5 to 30 nm are mixed, and

a coefficient of determination between an atomic concentration of Fe and an atomic concentration of the at least one of metalloid element is 0.700 or more.

Since the soft magnetic alloy of the present invention has the above-described characteristics, a soft magnetic alloy having a high saturation magnetic flux density Bs and low coercivity He can be provided.

The soft magnetic alloy may further include at least one of M, M being transition elements of Group 4 to Group 6, in which

a coefficient of determination between the atomic concentration of Fe and an atomic concentration of the at least one of M may be 0.700 or more.

The soft magnetic alloy may have an Fe-M-Z based composition,

M is one or more of transition metals of Group 4 to Group 6, and Z is two or more of C, P, Si, B, and Ge,

an element among Z having the highest content ratio as a ratio of the number of atoms with respect to the entirety of the soft magnetic alloy is set as Z1, and an element among Z having the highest content ratio except Z1 is set as Z2,

a coefficient of determination between an atomic concentration of M and an atomic concentration of Z1 may be 0.600 or more, or a coefficient of determination between the atomic concentration of M and an atomic concentration of Z2 may be 0.600 or more, and

a coefficient of determination between the atomic concentration of Z1 and the atomic concentration of Z2 may be less than 0.400.

The soft magnetic alloy may have an Fe-M-Z based composition,

M is one or more of transition metals of Group 4 to Group 6, and Z is two or more of C, P, Si, B, and Ge,

an element among Z having the highest content ratio as a ratio of the number of atoms with respect to the entirety of the soft magnetic alloy is set as Z1, and an element among Z having the highest content ratio except Z1 is set as Z2,

a coefficient of determination between an atomic concentration of M and an atomic concentration of Z1 may be less than 0.500, or a coefficient of determination between the atomic concentration of M and an atomic concentration of Z2 may be less than 0.500, and

a coefficient of determination between the atomic concentration of Z1 and the atomic concentration of Z2 may be less than 0.400.

The Fe-M-Z based composition may be expressed by a compositional formula of (Fe_{(1-(α+β))}X1_{α}X2_{β})_{(1-(a+b+c))}M1ₐZ_{b}Cr_{c},

X1 is one or more of Co and Ni,

X2 is one or more of Al, Mn, Ag, Zn, Sn, Cu, Bi, N, O, S, and a rare-earth element,

M1 is one or more of Ta, V, Zr, Hf, Ti, Nb, Mo, and W,
0.030≤a≤0.140,
0.030≤b≤0.275,
0.000≤c≤0.030,
0≤α(1−(a+b+c))≤0.400,
β≥0, and
0≤α+β≤0.50 may be satisfied.
0.050≤b≤0.200 may be satisfied.
0.730≤1−(a+b+c)≤0.930 may be satisfied.

The soft magnetic alloy may have an Fe-M-C composition,

a peak of an M-C compound may not be observed in an XRD chart of the soft magnetic alloy, and

the soft magnetic alloy may have a first region in which a total concentration of Fe, Co, and Ni is 85 at % or more and a second region in which the total concentration of Fe, Co, and Ni is 80 at % or less, and an average of M/C that is a value obtained by dividing an atomic concentration of M by an atomic concentration of C in the second region may be more than 1.0.

The Fe-M-C based composition may be expressed by a compositional formula of (Fe_{(1-(α+β))}X1_{α}X2_{β})_{(1-(a+b1+b2+c))}M1ₐC_{b3}Z3_{b4}Cr_{c},

X1 is one or more of the group consisting of Co and Ni,

X2 is one or more of the group consisting of Al, Mn, Ag. Zn, Sn, As, Sb, Cu, Bi, N, O, S, and a rare-earth element,

M1 is one or more of the group consisting of Ta, V, Zr, Hf, Ti, Nb, Mo, and W,

Z3 is one or more of the group consisting of P, B, Si, and Ge,
0.030≤a≤0.140,
0.005≤b3≤0.200.
0.000≤b4≤0.180,
0.000≤c≤0.030,
0≤α(1−(a+b3+b4+c))≤0.400,
β≥0, and
0≤α+β≤0.50 may be satisfied.
0.040≤b3≤0.120 may be satisfied.
0.730≤1−(a+b3+b4+c)≤0.930 may be satisfied.
0.050≤a≤0.140 may be satisfied.

The soft magnetic alloy may contain Fe-based nanocrystals.

The soft magnetic alloy may have a ribbon shape.

The soft magnetic alloy may have a powder shape.

The soft magnetic alloy may have a thin film shape.

A magnetic component of the present invention includes the above soft magnetic alloy.

### BRIEF DESCRIPTION OF DRAWINGS

FIG. 1 is an example of a scatter diagram created from an atomic concentration of Fe and an atomic concentration of Z;

FIG. 2 is an example of a scatter diagram created from an atomic concentration of Fe and an atomic concentration of Z;

FIG. 3 is a schematic diagram of a microstructure of a soft magnetic alloy 1 according to the present embodiment;

FIG. 4 is a schematic diagram of a microstructure of a soft magnetic alloy 101 of the related art;

FIG. 5 is a schematic diagram of a microstructure of a soft magnetic alloy 201 of the related art;

FIG. 6 is an example of a chart obtained by crystal structure analysis by XRD for a soft magnetic alloy;

FIG. 7 is an example of a pattern obtained by profile fitting the chart in FIG. 6;

FIG. 8 is an Fe mapping image obtained by 3DAP measurement;

FIG. 9 is a Ta mapping image obtained by 3DAP measurement; and

FIG. 10 is a C mapping image obtained by 3DAP measurement.

### DETAILED DESCRIPTION OF INVENTION

Hereinafter, the present invention will be described based on embodiments shown in the drawings.

A soft magnetic alloy of this embodiment is a soft magnetic alloy including Fe and at least one of metalloid elements. An amorphous material and a nanocrystal having a grain size of 5 to 30 nm are mixed, and a coefficient of determination between an atomic concentration of Fe and an atomic concentration of the at least one of metalloid elements is 0700 or more.

When causing a status of microscopic segregation or dispersion of respective elements included in the soft magnetic alloy to vary, soft magnetic characteristics of the soft magnetic alloy vary. In addition, the status of the microscopic segregation or dispersion the respective elements included in the soft magnetic alloy varies in accordance with a composition of the soft magnetic alloy and heat treatment conditions (thermal hysteresis of the soft magnetic alloy).

Description will be given of a method of confirming a status of microscopic segregation or dispersion with respect to two of elements included in the soft magnetic alloy.

At a plurality of measurement sites in the soft magnetic alloy, atomic concentrations of the two of elements are measured. Then, the atomic concentrations of the two of elements are respectively set as an X-axis and a Y-axis, and the concentrations of the two of elements at the respective measurement sites are plotted to obtain a scatter diagram. Then, regression analysis is performed to obtain a primary regression equation (y=ax+b).

In a case where a is positive, the two of elements are likely to coexist with each other and are likely to aggregate. In a case where a is negative, the two of elements are likely to be exclusive to each other, and are likely to be separated from each other. Then, the two of elements are likely to be segregated.

In a case of obtaining the scatter diagram from an atomic concentration of Fe and an atomic concentration of a metalloid element in a soft magnetic alloy in which Fe and the metalloid element are included and an amorphous material and a nanocrystal are mixed, a is likely to be negative. That is, in the soft magnetic alloy, Fe and the metalloid element are likely to be exclusive with each other and are likely to be separated from each other. Specifically, Fe is likely to be included in the nanocrystal, the metalloid element is less likely to be included in the nanocrystal, the metalloid element is likely to be included in the amorphous material, and Fe is less likely to be included in the amorphous material.

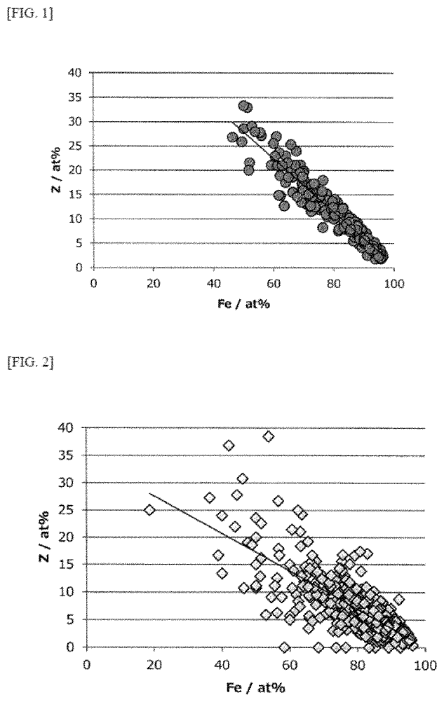

FIG. 1 and FIG. 2 illustrate an example of the scatter diagram. Note that, in the scatter diagram, an x-axis (horizontal axis) represents the atomic concentration of Fe, and a y-axis (vertical axis) represents the atomic concentration of the metalloid element. Also, the metalloid element is set as Z.

Here, a coefficient of determination R² can be obtained from the primary regression equation. The larger the coefficient of determination is, the more the two of elements are likely to aggregate or disperse with each other. That is, an effect on each of the two of elements is large. In contrast, the smaller the coefficient of determination is, the smaller an effect on each of the two of elements is.

FIG. 1 is a scatter diagram in which the coefficient of determination is approximately 0.9. FIG. 2 is a scatter diagram in which the coefficient of determination is approximately 0.6. In FIG. 1, Fe is more likely to be included in a nanocrystal and Z is less likely to be included in the nanocrystal in comparison to FIG. 2. Furthermore, in FIG. 1, Z is more likely to be included in an amorphous material and Fe is less likely to be included in the amorphous material in comparison to FIG. 2. That is. Fe and Z are further separated in FIG. 1 in comparison to FIG. 2. In a case of obtaining the scatter diagram from an atomic concentration of Fe and an atomic concentration of Z in a soft magnetic alloy in which Fe and the metalloid element are included and an amorphous material and a nanocrystal are mixed, the inventors found that the larger the coefficient of determination is, the more magnetic characteristics are likely to be improved. That is, the further Fe and Z are separated from each other, the more the magnetic characteristics are improved. In other words, the further Fe aggregates to the nanocrystal and Z aggregates to the amorphous material, the more the magnetic characteristics are likely to be improved.

The status of the microscopic segregation or dispersion of the respective elements included in the soft magnetic alloy can be observed and measured by using three-dimensional atom probe (3DAP).

Hereinafter, the three-dimensional atom probe (3DAP) will be described.

3DAP is a device that is used to obtain three-dimensional atomic arrangement information. Hereinafter, a procedure of measurement using the 3DAP will be described. First, a high voltage is applied to a sample processed into a needle shape, and a laser pulse is further applied to the sample. According to this, electrolytic evaporation occurs at a tip end of the sample. Ions generated due to the electrolytic evaporation are detected by a two-dimensional detector to specify atomic arrangement of the sample. Simultaneously, the kind of an ion can also be specified from flight time of the ion.

Then, measurement data obtained by the 3DAP is analyzed by using software. According to this, an observation range can be virtually divided with a plurality of hexagonal grids set to an arbitrary size. Each of the hexagonal grids has composition information calculated from the measurement data. According to this, microscopic composition information can be statistically dealt and analyzed. Accordingly, when using the 3DAP, a microscopic composition fluctuation of the sample can be three-dimensionally observed. In addition, the atomic arrangement in the sample can be observed. That is, microscopic segregation or dispersion of each element included in the sample can be observed.

The inventors observed microscopic segregation or dispersion of each element by using the 3DAP with respect to samples prepared by changing a composition and heat treatment conditions. Furthermore, measurement of magnetic characteristics (saturation magnetic flux density Bs, coercivity He, and the like) was performed by using a vibrating sample magnetometer (VSM). As a result, it could be understood that when changing the composition of the soft magnetic alloy and the heat treatment conditions, a concentration distribution of each element included in the soft magnetic alloy varies. Furthermore, the inventors found that when changing the composition of the soft magnetic alloy and the heat treatment conditions, dependency of a concentration distribution of each element on a concentration distribution of another element varies. Furthermore, the inventors found that a variation in a concentration ratio between Fe atoms and metalloid atoms in a microregion of the soft magnetic alloy has a great correlation with magnetic characteristics of the soft magnetic alloy. Note that, examples of the metalloid elements include B, C, Al, Si, P, Ge, As, Se, Sb, Te, Po, At, and the like.

An example of the measurement conditions for a sample in the 3DAP is described below. Measurement is performed in a measurement range of a rectangular parallelepiped or cube having dimensions of at least 40 nm×40 nm×50 nm as lengths of respective sides. The rectangular parallelepiped or cube (measurement range) is virtually divided into grids having a cubic shape in which a length of one side is 2 nm by analyzing measurement data obtained by using software. That is, grids which individually have composition information exist in a number of 20×20×25=10000 or more. Note that, a shape of the measurement range is not particularly limited, and 10000 or more grids may exist continuously. A plurality of the grids respectively having composition information can be statistically dealt and analyzed. The inventors found an analysis method of obtaining a coefficient of determination R² of an atomic concentration of Fe and an atomic concentration of at least one of metalloid elements. Specifically, a scatter diagram is created from the atomic concentration of Fe and the atomic concentration of the at least one of metalloid element in each grid. Next, a primary regression equation can be obtained by performing regression analysis. Then, the coefficient of determination R² can be obtained from the primary regression equation. Hereinafter, the metalloid element may be set as Z, and the coefficient of determination between the atomic concentration of Fe and the atomic concentration of Z may be set as R²(Fe—Z). In addition, a similar notation may be performed with respect to the other coefficient of determination.

When R²(Fe—Z) is set to 0.700 or more, a soft magnetic alloy having a high saturation magnetic flux density Bs and low coercivity He can be obtained. The reason for this is as follows. In the soft magnetic alloy of this embodiment, an amorphous material and a nanocrystal having a grain size of 5 to 30 nm are mixed, Fe aggregates to a nanocrystal phase, and a metalloid element aggregates to an amorphous phase, and thus R²(Fe—Z) increases. In contrast, the further the metalloid element is included in the nanocrystal in a high concentration, the further R²(Fe—Z) decreases, and particularly, the further the saturation magnetic flux density Bs decreases.

The soft magnetic alloy may further contain at least one of M in addition to Fe and at least one of metalloid element. M is a transition metal of Group 4 to Group 6. The coefficient of determination R²(Fe-M) can be obtained from an atomic concentration of Fe and an atomic concentration of the at least one of M in each grid by the above-described method. R²(Fe-M) is preferably 0.700 or more. When R²(Fe-M) is 0.700 or more, magnetic characteristics, particularly, Bs is likely to be improved. The reason for this is as follows. In the soft magnetic alloy of this embodiment, an amorphous material and a nanocrystal having a grain size of 5 to 30 nm are mixed. Fe aggregates to the nanocrystal phase, and the M element aggregates to the amorphous phase, and thus R²(Fe-M) increases. In contrast, the further the M element is included in the nanocrystal phase in a high concentration, the further R²(Fe-M) decreases, and particularly, the further the saturation magnetic flux density Bs decreases.

Hereinafter, a case where the composition is further specifically specified will be described. Specifically, a case of an Fe-M-Z based composition and a case of an Fe-M-C based composition will be described.

(1) Fe-M-Z Based Composition and Coefficient of Determination

The soft magnetic alloy according to this embodiment may be a soft magnetic alloy having the Fe-M-Z based composition. M is one or more of transition metals of Group 4 to Group 6, and Z is two or more of C, P, Si, B, and Ge.

The Fe-M-Z based composition is a composition mainly including Fe, M, and Z. In addition, a part of Fe may be substituted with Co and/or Ni. Specifically, 40 at % or less of the entirety of Fe may be substituted with Co and/or Ni. In addition, a total content of Fe, Co, and Ni may be 73 at % or more with respect to the entirety of the soft magnetic alloy. Note that, in a case where the soft magnetic alloy has the Fe-M-Z based composition, a total content of elements other than Fe, Co, Ni, M, and Z in the soft magnetic alloy is 25 at % or less with respect to the entirety of the soft magnetic alloy. Examples of the elements other than Fe, Co, Ni. M, and Z include Al, Mn, Ag, Zn, Sn, As, Sb, Cu, Bi, N, O, S, and a rare-earth element.

M is one or more of transition metals of Group 4 to Group 6. For example, M may be one or more of the group consisting of Ta, V, Zr, Hf, Ti, Nb, Mo, and W. Z is two or more of C, P, Si, B, and Ge. Note that, M and Z may be coupled to each other to form a crystal of an M-Z compound. Hereinafter, one or more of elements selected from the group consisting of Ta, V, Zr, Hf, Ti, Nb, Mo, and W are noted as M1. Examples of M other than M1 include Cr.

In the soft magnetic alloy of this embodiment, M1 content may be 3.0 to 14.0 at %, or may be 7.0 to 9.0 at %. Z content may be 3.0 to 27.5 at %, or 5.0 to 16.0 at %. Cr content may be 0 to 3.0 at %. That is, the soft magnetic alloy of this embodiment may not include Cr. In addition, in the soft magnetic alloy of this embodiment, Ta is preferably included in an amount of 3 at % or more with respect to the entirety of M1 because particularly, the saturation magnetic flux density Bs is likely to be improved and the coercivity He is likely to decrease. In addition, Ta may be included in an amount of 40 at % or more with respect to the entirety of M1.

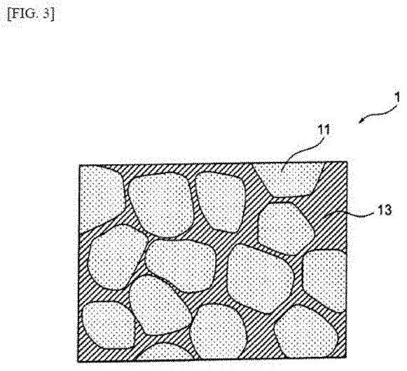

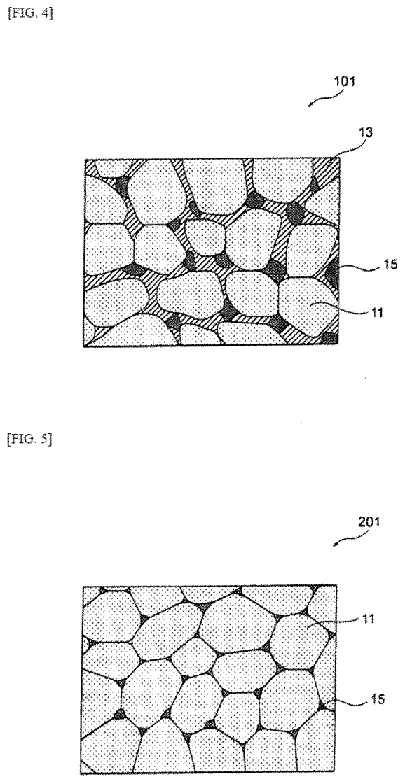

A microstructure of the soft magnetic alloy of this embodiment is not particularly limited. The soft magnetic alloy of this embodiment includes M and Z, but a crystal of an M-Z compound may not be precipitated, and it is preferable that the M-Z compound is not substantially included. M and Z may be included as the amorphous material. That is, as illustrated in FIG. 3, a soft magnetic alloy 1 of this embodiment includes an α-Fe phase 11 composed of a crystal and an amorphous phase 13. However, it is preferable that the soft magnetic alloy 1 does not substantially include an M-Z compound phase 15 as illustrated in FIG. 4 and FIG. 5.

A state in which the M-Z compound phase 15 is not substantially included represents that a peak of the M-Z compound is not observed in an XRD chart of the soft magnetic alloy. That is, a crystal of the M-Z compound is not substantially included. Description of “a peak of the M-Z compound is not observed in an XRD chart” represents that a peak intensity of (200) of the M-Z compound is 5% or less with respect to a peak intensity of α-Fe (110) in a chart after removing background. The peak intensity of (200) may be 1% or less. In general, with regard to accuracy of quantitative analysis with XRD, a relative error is approximately 1% to 5% or equal to or more than this range, and thus it is considered that the criteria for being substantially free of the crystal of the M-Z compound are appropriate.

Here, an element among Z having the highest content ratio as a ratio of the number of atoms with respect to the entirety of the soft magnetic alloy is set as Z1, and an element among Z having the highest content ratio except Z1 is set as Z2. That is, Z1 and Z2 are metalloid elements having a relatively high concentration in a composition of the soft magnetic alloy. Note that, in a case where content ratios of two or more of elements are the same as each other, it is assumed that content ratios are higher in the order of C, P, B, Si, and Ge. Note that, a total content ratio of Z other than Z1 and Z2 is not particularly limited. For example, when the entirety of Z is set to 100 at %, the total content ratio of Z other than Z1 and Z2 may be 50 at % or less.

In the soft magnetic alloy having the Fe-M-Z based composition, when causing a status of microscopic segregation or dispersion of respective elements included in the soft magnetic alloy to vary, soft magnetic characteristics of the soft magnetic alloy vary. In addition, the status of the microscopic segregation or dispersion the respective elements included in the soft magnetic alloy varies in accordance with a composition of the soft magnetic alloy and heat treatment conditions (thermal hysteresis of a soft magnetic alloy).

The status of microscopic segregation or dispersion of respective elements included in the soft magnetic alloy can be observed and measured by using the three-dimensional atom probe (3DAP) as described above.

The inventors observed the microscopic segregation or dispersion of the respective elements by using the 3DAP with respect to a sample prepared by changing the composition and the heat treatment conditions. Furthermore, measurement of the magnetic characteristics was performed by using VSM. As a result, they found that a variation in a concentration ratio between transition metals and metalloids in a microregion of the soft magnetic alloy has a great correlation with the magnetic characteristics of the soft magnetic alloy. Note that, observation conditions with the 3DAP can be set to be similar to the above-described observation conditions.

A measurement range of the sample in the 3DAP and setting of the grid, and the like are as described above. Then, the inventors performed analysis from an atomic concentration of a transition metal, that is, M, an atomic concentration of Z1, and an atomic concentration of Z2 in each grid to the atomic concentration of M and the atomic concentration of Z1, the atomic concentration of M and the atomic concentration of Z2, and the atomic concentration of Z1 and the atomic concentration of Z2. Hereinafter, a coefficient of determination between the atomic concentration of M and the atomic concentration of Z1 may be set as R²(M-Z1), a coefficient of determination between the atomic concentration of M and the atomic concentration of Z2 may be set as R²(M-Z2), and a coefficient of determination between the atomic concentration of Z1 and the atomic concentration of Z2 may be set as R²(Z1-Z2).

R²(M-Z1) may be 0.600 or more or R²(M-Z2) may be 0.600 or more, and R²(Z1-Z2) may be less than 0.400. Of R²(M-Z1) and R²(M-Z2), the one that does not 0.600 or more may be less than 0.500.

From another viewpoint, R²(M-Z1) may be less than 0.500 or R²(M-Z2) may be less than 0.500, and R²(Z1-Z2) may be less than 0.400. Of R²(M-Z1) and R²(M-Z2), the one that does not less than 0.500 may be 0.600 or more.

In a case where R²(M-Z1) or R²(M-Z2) is less than 0.500, or R²(M-Z1) or R²(M-Z2) is 0.600 or more, the coercivity He decreases. In addition, the saturation magnetic flux density Bs increases.

In addition, in a case where R²(Z1-Z2) is small, the coercivity He becomes low.

The inventors found that when an amorphous phase included in a soft magnetic alloy is set to be non-uniform, and a local variation of the concentration of M or Z is controlled, the saturation magnetic flux density Bs of the soft magnetic alloy becomes high, and the coercivity He becomes low. Specifically, the inventors found that in a case where R²(M-Z1) or R²(M-Z2) is 0.600 or more, and R²(Z1-Z2) is less than 0.400, the saturation magnetic flux density Bs of the soft magnetic alloy becomes high, and the coercivity He becomes low. In addition, the inventors found that in a case where R²(M-Z1) or R²(M-Z2) is less than 0.500, and R²(Z1-Z2) is less than 0.400, the saturation magnetic flux density Bs of the soft magnetic alloy also becomes high, and the coercivity He also becomes low.

Note that, the upper limit and the lower limit of R²(M-Z1) and R²(M-Z2) are not particularly limited. For example, the upper limit may be 0.750 or less. In addition, the lower limit may be 0.308 or more. Furthermore, the lower limit of R²(Z1-Z2) is not particularly limited. R²(Z1-Z2) may be 0.100 or more, or may be 0.203 or more.

In addition, in the soft magnetic alloy of this embodiment, the Fe-M-Z based composition may be expressed by a compositional formula of (Fe_{(1-(α+β))}X1_{α}X2_{β})_{(1-(a+b+c))}M1ₐZ_{b}Cr_{c},

X1 may be one or more of Co and Ni,

X2 may be one or more of Al, Mn, Ag, Zn, Sn, Cu, Bi, N, O, S, and a rare-earth element,

M1 may be one or more of Ta, V, Zr, Hf, Ti, Nb, Mo, and W.
0.030≤a≤0.140,
0.030≤b≤0.275,
0.000≤c≤0.030,
0≤α(1−(a+b+c))≤0.400,
β≥0, and
0≤α+β0.50 may be satisfied,

The M1 content (a) may satisfy 0.050≤a≤0.140, or 0.070≤a≤0.090. Even when the M1 content (a) is large or small, the coercivity He is likely to be high, and the saturation magnetic flux density Bs is likely to be low.

It is preferable that Ta is included as M1 because particularly, the saturation magnetic flux density Bs is likely to be high and the coercivity He is likely to be low. In addition, with respect to the entirety of M1, Ta may be included in an amount of 3 at % or more, or Ta may be included in an amount of 40 at % or more.

The Z content (b) may satisfy 0.050≤b≤0.200, or 0.050≤b≤0.160. Even when the Z content (b) is large or small, the coercivity He is likely to be high. In a case where the Z content (b) is large, the saturation magnetic flux density Bs is further likely to be low.

Z1 may be C and Z2 may be P, B, or Si, or Z1 may be C and Z2 may be P. The coercivity He is likely to be low. In addition, a ratio of the Z2 content to the Z content may be 0.0375 to 1.00 as a ratio of the number of atoms, or may be 0.125 to 1.00. When the ratio of the Z2 content to the Z content of Z is 0.125 to 1.00, the coercivity He is likely to be low.

The Cr content (c) may satisfy 0.000≤c≤0.010. In a case where the Cr content is large, the coercivity He is likely to be high, and the saturation magnetic flux density Bs is likely to be low.

The Fe content (1−(a+b+c)) may satisfy 0.585≤1−(a+b+c)≤0.930, 0.730≤1−(a+b+c)≤0.930, or 0.730≤(1−a+b+c)≤0.890. When the Fe content (1−(a+b+c)) is within the above-described ranges, amorphous material formability of the soft magnetic alloy becomes high, and a crystal having a grain size more than 30 nm is less likely to be generated at the time of manufacturing the soft magnetic alloy.

In addition, in the soft magnetic alloy of this embodiment, a part of Fe may be substituted with X1 and/or X2.

X1 is one or more selected from the group consisting of Co and Ni. When X1 is Ni, there is an effect of lowering the coercivity He, and when X1 is Co, it is easy to improve the saturation magnetic flux density Bs. The kind of X1 can be appropriately selected. α may be 0. That is, X1 may not be included. In addition, when the number of atoms of the entirety of composition is set to 100 at %, the number of atoms of X1 may be 40 at % or less. That is, 0≤α(1−(a+b+c))≤0.400 may be satisfied. 0≤α(1−(a+b+c))≤0.100 may be satisfied. When the number of atoms of X1 increases, magnetostriction increases and the coercivity He is likely to be high.

X2 is one or more of Al, Mn, Ag, Zn, Sn, Cu, Bi, N, O, S, and a rare-earth element. In addition, with regard to the X2 content, β may be 0. That is, X2 may not be included. In addition, when the number of atoms of the entirety of composition is set to 100 at %, the number of atoms of X2 is preferably 3.0 at % or less. That is, it is preferable to satisfy 0≤β(1−(a+b+c))≤0.030.

The range of the amount of substitution of Fe with X1 and/or X2 may be set to be equal to or lower than approximately the half of Fe on the basis of the number of atoms. That is, 0≤α+β≤0.50 may be satisfied.

Furthermore, the soft magnetic alloy of this embodiment may contain elements other than the above-described elements as unavoidable impurities. For example, the unavoidable impurities may be respectively included in an amount of 0.1 wt % or less with respect to 100 wt % of soft magnetic alloy.

In addition, the soft magnetic alloy of this embodiment may have a structure including an Fe-based nanocrystal.

Here, the Fe-based nanocrystal represents a crystal which has a nano-order grain size, and in which a crystal structure of Fe is a body centered cubic structure (bcc). In this embodiment, it is preferable to precipitate Fe-based nanocrystal having an average grain size of 5 to 30 nm.

In addition, in a case where the soft magnetic alloy composed of an amorphous material is subjected to a heat treatment, the Fe-based nanocrystal is likely to precipitate in the soft magnetic alloy. In other words, the soft magnetic alloy that has the above-described composition and is composed of an amorphous material is easy to be set as a raw material of the soft magnetic alloy of this embodiment which has the structure including the Fe-based nanocrystal.

In addition, the soft magnetic alloy before the heat treatment may have a structure composed of only the amorphous material, or may have a nanohetero structure in which microcrystals exist in the amorphous material. Note that, the microcrystals may have an average grain size of 0.3 to 10 nm.

Hereinafter, an amorphization rate of the soft magnetic alloy will be described.

In a case where the soft magnetic alloy according to this embodiment is bulk as described later, it is assumed that a soft magnetic alloy in which an amorphization rate X expressed by the following Expression (1) is 85% or more has a structure constituted by an amorphous material, and a soft magnetic alloy in which the amorphization rate X is less than 85% has a structure constituted by crystals.

X=100−(Ic/(Ic+Ia)×100) (1)

Ic: Crystalline scattering integrated intensity

Ia: Amorphous scattering integrated intensity

With regard to the amorphization rate X, crystal structure analysis for a soft magnetic alloy is performed by XRD, identification of a phase is performed, peaks (Ic: crystalline scattering integrated intensity, Ia: amorphous scattering integrated intensity) of crystallized Fe or a compound are read, a crystallization rate is calculated from the peak intensities, and then the amorphization rate X is calculated by the following Expression (1). Hereinafter, a calculation method will be described in more detail.

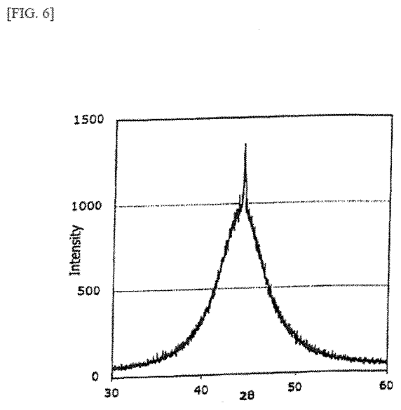

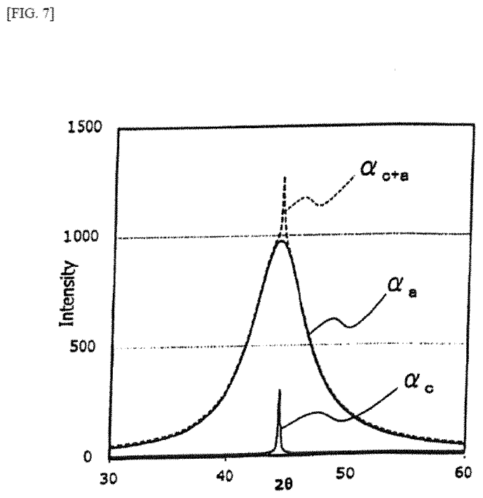

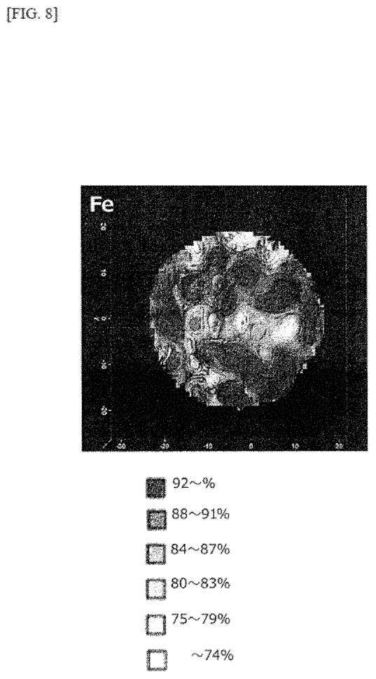

Crystal structure analysis with XRD is performed for the soft magnetic alloy according to this embodiment to obtain a chart illustrated in FIG. 6. Profile fitting is performed by using a Lorenz function in the following Expression (2) to obtain a crystal component pattern α_{c} representing the crystalline scattering integrated intensity, an amorphous component pattern αₐ representing the amorphous scattering integrated intensity, and a pattern α_{c+a} obtained by combining the patterns as illustrated in FIG. 7. The amorphization rate X is obtained by Expression (1) from the crystalline scattering integrated intensity and the amorphous scattering integrated intensity of the obtained pattern. Note that, a measurement range is set to a range of a diffraction angle 2θ=30° to 60° at which an amorphous material-derived halo can be confirmed. In this range, an error between an integrated intensity that is actually measured with XRD and an integrated intensity calculated by using a Lorenz function is set within 1%.

$$\begin{matrix}[ Formula 1 ] & \\ f ( x ) = \frac{h}{1 + \frac{{( x - u )}^{2}}{{w}^{2}}} + b & ( 2 )\end{matrix}$$

h: peak height
u: peak position
w: full width at half maximum
b: background height

In a case where the soft magnetic alloy according to this embodiment is a thin film to be described later, crystal structure analysis with XRD may be performed by using a method of In-Plane diffraction measurement. In this case, a similar chart as in the case of performing the crystal structure analysis with XRD for bulk by using a typical method is obtained. When performing similar analysis for the chart of the thin film as in analysis performed for the chart of bulk, the amorphization rate X can be calculated.

(2) Fe-M-C Based Composition and M/C

The soft magnetic alloy of this embodiment may be soft magnetic alloy having an Fe-M-C based composition.

The Fe-M-C based composition is a composition that mainly contains Fe, M, and C. In addition, a part of Fe may be substituted with Co and/or Ni. Specifically, 40 at % or less of the entirety of Fe may be substituted with Co and/or Ni. In addition, a total content of Fe, Co, and Ni may be 70 at % or more with respect to the entirety of the soft magnetic alloy. Note that, in a case where the soft magnetic alloy has the Fe-M-C based composition, a total content of elements other than Fe, Co, Ni, M, and C in the soft magnetic alloy is 25 at % or less with respect to the entirety of the soft magnetic alloy. Examples of the elements other than Fe, Co, Ni, M, and C include P, B, Si, Ge, Al, Mn, Ag, Zn, Sn, As, Sb, Cu, Cr, Bi, N, O, S, and a rare-earth element.

M is a metal element that can be bonded to C to form a crystal of an M-C compound. Examples of M include one or more selected from the group consisting of Ta, V, Zr, Hf, Ti, Nb, Mo, and W. In the soft magnetic alloy of this embodiment, the M content may be 3 at % or more, and the M content may be 3 to 14 at %, or 5 to 12 at %. In addition, in the soft magnetic alloy of this embodiment, Ta is preferably included in an amount of 3 at % or more with respect to the entirety of M because particularly, the saturation magnetic flux density Bs is likely to be improved and the coercivity He is likely to be decreased. In addition, Ta may be included in an amount of 40 at % or more with respect to the entirety of M.

In the soft magnetic alloy of this embodiment, the C content may be 0.5 at % or more or 4 at % or more.

In the soft magnetic alloy of this embodiment, a peak of the M-C compound is not observed in an XRD chart. That is, the soft magnetic alloy does not substantially contain a crystal of the M-C compound. Description of “a peak of the M-C compound is not observed in an XRD chart” represents that a peak intensity of (200) of the M-C compound is 5% or less with respect to a peak intensity of α-Fe (110) in a chart after removing background. The peak intensity of (200) may be 1% or less. In general, with regard to accuracy of quantitative analysis with XRD, a relative error is approximately 1% to 5% or equal to or more than this range, and thus it is considered that the criteria for being substantially free of the crystal of the M-C compound are appropriate.

The soft magnetic alloy of this embodiment contains M and C, but a crystal of the M-C compound does not precipitate and the M-C compound is not substantially included. The soft magnetic alloy contains M and C as an amorphous material. That is, as illustrated in FIG. 3, the soft magnetic alloy 1 of this embodiment includes the α-Fe phase 11 composed of a crystal and the amorphous phase 13, but does not substantially include the M-C compound.

In contrast, as illustrated in FIG. 4 and FIG. 5, a soft magnetic alloy of the related art includes an M-C compound phase 15 composed of the M-C compound. A soft magnetic alloy 101 including an amorphous phase 13 illustrated in FIG. 4, and a soft magnetic alloy 201 that does not include an amorphous phase 13 illustrated in FIG. 5 can be selectively formed by mainly controlling a ratio of the number of atoms of M/C in the entirety of the soft magnetic alloy. In a case where the ratio of the number of atoms of M/C in the entirety of the soft magnetic alloy is more than 1.0, the soft magnetic alloy 101 is likely to include the amorphous phase 13. In a case where the ratio of the number of atoms of M/C is 1.0 or less, the soft magnetic alloy 201 is substantially likely to include only the α-Fe phase 11 and the M-C compound phase 15. In addition, in the soft magnetic alloy 101 illustrated in FIG. 4 and the soft magnetic alloy 201 illustrated in FIG. 5, coercivity of the soft magnetic alloy 201 illustrated in FIG. 5 is more likely to decrease. Furthermore, when changing a heat treatment temperature, various microstructures other than the microstructures illustrated in FIG. 4 and FIG. 5 can be formed.

The soft magnetic alloy of this embodiment includes a first region in which a total concentration of Fe, Co, and Ni is 85 at % or more, and a second region in which a total concentration of Fe, Co, and Ni is 80 at % or less. Distinction of the first region, the second region, and the other regions is performed by using the 3DAP. Note that, measurement sites using 3DAP is not particularly limited. The measurement sites may be a surface of the soft magnetic alloy, or a cut surface obtained by cutting the soft magnetic alloy.

An example of a method of measuring the ratio M/C of the number of atoms by using the 3DAP will be described below. First, measurement is performed by setting a rectangular parallelepiped in which lengths of respective sides are at least 40 nm×40 nm×50 nm as or a cube as a measurement range. Obtained measurement data is analyzed by using software to virtually divide the rectangular parallelepiped or cube (measurement range) into a grid having a cubic shape in which a length of one side is 1 nm. That is, grids individually having composition information exist in a number of 40×40×50=80000 or more. Note that, with regard to the measurement range according to this embodiment, a shape of the measurement range is not particularly limited, and 80000 or more grids may exist continuously. In addition, a plurality of grids respectively having composition information can be statistically dealt and analyzed.

Among the grids, a grid in which a total concentration of Fe, Co, and Ni is 85 at % or more becomes a grid (first region grid) that constitutes the first region. In addition, a grid in which a total concentration of Fe, Co, and Ni is 80 at % or less becomes a grid (second region grid) that constitutes the second region. Note that, the first region is generally composed of a crystal, and the second region is generally composed of an amorphous material.

The measurement performed by using the 3DAP is performed at least two or more times by setting measurement ranges different from each other, and preferably three or more times. Then, volume ratios of the first region which are obtained in the measurement are averaged to calculate a volume ratio of the first region in the soft magnetic alloy. This is also true of a volume ratio of the second region.

Note that, the volume ratio of the first region and the volume ratio of the second region in the soft magnetic alloy are not particularly limited. The volume ratio of the first region may be 5 to 90 vol %. The volume ratio of the second region may be 10 to 90 vol %. The volume ratio of the first region in the soft magnetic alloy may be the same as a number ratio of the first region grid included in 80000 or more grids. The volume ratio of the second region in the soft magnetic alloy may be the same as a number ratio of the second region grid included in 80000 or more grids.

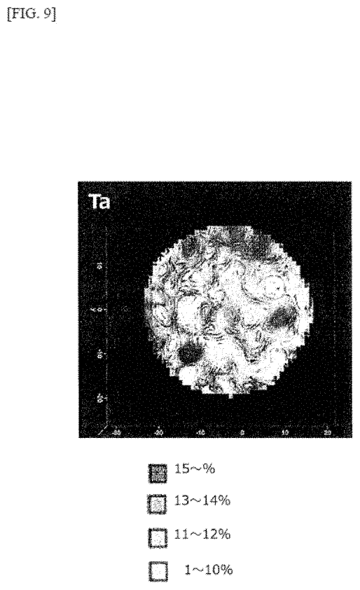

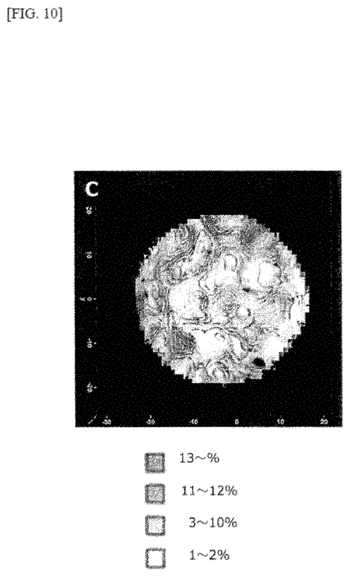

The 3DAP measurement is performed for the soft magnetic alloy of this embodiment which does not contain Co and Ni, and M is only Ta, and a mapping image of each element is created. The result is shown in FIG. 8 to FIG. 10. It can be seen that at a site where the Fe content is large, the Ta content and the C content are small.

In each second region grid, a value obtained by calculating and averaging M/C ratios as a value obtained by dividing an atomic concentration of M by an atomic concentration of C exceeds 1.0.

As described above, the soft magnetic alloy having the Fe-M-C based composition does not substantially include a crystal of the M-C compound, and an average of M/C that is a value obtained by dividing the atomic concentration of M by the atomic concentration of C in the second region exceeds 1.0. In the soft magnetic alloy having the above-described characteristics, the saturation magnetic flux density Bs is more likely to be high and the coercivity Hc is more likely to be low in comparison to a soft magnetic alloy that has the same composition and includes a crystal of the M-C compound, or a soft magnetic alloy which has the same composition and in which the average of M/C in the second region is 1.0 or less. The average of M/C in the second region may be 1.2 to 2.8, or 1.2 to 2.5.

In addition, in the soft magnetic alloy of this embodiment, the Fe-M-C based composition may be expressed by a composition formula of Fe_{(1-(α+β))}X1_{α}X2_{β})_{(1-(a+b3+b4+c))}MₐC_{b3}X3_{b4}Cr_{c},

X1 may be one or more selected from the group consisting of Co and Ni,

X2 may be one or more selected from the group consisting of Al, Mn, Ag, Zn, Sn, As, Sb, Cu, Bi, N, O, S, and a rare-earth element,

M may be one or more selected from the group consisting of Ta, V, Zr, Hf, Ti, Nb, Mo, and W,

X3 may be one or more selected from the group consisting of P, B, Si, and Ge,
0.030≤a≤0.140,
0.005≤b3≤0.200,
0.000≤b4≤0.180,
0.000≤c≤0.030,
0≤α(1−(a+b3+b4+c))≤0.400,
β≥0, and
0≤α+β≤0.50 may be satisfied.

M is one or more selected from the group consisting of Ta, V, Zr, Hf, Ti, Nb, Mo, and W. M is preferably one or more selected from Ta, V, and W, and M is more preferably Ta.

The M content (a) may satisfy 0.030≤a≤0.140. The M content (a) may satisfy 0.050≤a≤0.140. Even when the M content (a) is large or small, the coercivity Hc is likely to be high. In a case where the M content (a) is large, particularly, the coercivity Hc is likely to be high, and the saturation magnetic flux density Bs is also likely to be low. In a case where the M content (a) is small, particularly, the coercivity Hc is likely to be high.

The C content (b3) may satisfy 0.005≤b3≤0.200. In addition, 0.040≤b3≤0.120 or 0.040≤b3≤0.100 may be satisfied. In a case where the C content (b3) is small, the coercivity HC is likely to be high. In a case where the C content (b3) is large, the saturation magnetic flux density Bs is likely to be low, and the coercivity Hc is likely to be high.

X3 is one or more selected from the group consisting of P, B, Si, and Ge. X3 may be one or more selected from the group consisting of P, B, and Si.

The X3 content (b4) may satisfy 0.000≤b4≤0.180. 0.003≤b4≤0.180 or 0.010≤b4≤0.080 may be satisfied. In a case where the X3 content (b4) is small, amorphous material formability is likely to deteriorate, and the coercivity ie is likely to be high. In a case where the X3 content (b4) is large, the saturation magnetic flux density Bs is likely to be low, and the coercivity Hc is likely to be high.

In addition, the sum of the C content and the X3 content (b3+b4) may satisfy 0.080≤b3+b4≤0.130. When the sum of the C content and the X3 content (b3+b4) is within the above-described range, the coercivity He is likely to be high.

The Cr content (c) may satisfy 0.000≤c≤0.030. 0.003≤c≤0.030 may be satisfied. The larger the Cr content (c) is, the further oxidation resistance tends to be improved, but the larger the Cr content (c) is, the further the saturation magnetic flux density Bs tends to be low.

The Fe content (1−(a+b3+b4+c)) may satisfy 0.640≤(1−(a+b3+b4+c))≤0.930, or 0.730≤(1−(a+b3+b4+c))≤0.930. When a value of 1−(a+b3+b4+c) is within the above-described ranges, the amorphous material formability in the soft magnetic alloy becomes high, and a crystal having a grain size more than 30 nm is less likely to be generated at the time of manufacturing the soft magnetic alloy.

In addition, in the soft magnetic alloy of this embodiment, a part of Fe may be substituted with X1 and/or X2.

X1 is one or more selected from the group consisting of Co and Ni. When X1 is Ni, there is an effect of lowering the coercivity He, and when X1 is Co, the saturation magnetic flux density Bs after a heat treatment is likely to be improved. The kind of X1 can be appropriately selected. α may be 0. That is, X1 may not be included. In addition, when the number of atoms of the entirety of the composition is set to 100 at %, the number of atoms of X1 may be 40 at % or less. That is, 0≤α{1−(a+b3+b4+c)}≤0.400 may be satisfied. 0≤α{1−(a+b3+b4+c)}≤0.100 may be satisfied. When the number of atoms of X1 increases, magnetostriction increases and the coercivity He is likely to be high.

X2 is one or more selected from the group consisting of Al Mn, Ag, Zn, Sn, As, Sb, Cu, Bi, N, O, S. and a rare-earth element. In addition, with regard to the X2 content, β may be 0. That is, X2 may not be included. In addition, when the number of atoms of the entirety of the composition is set to 100 at %, the number of atoms of X2 is preferably 3.0 at % or less. That is, 0≤β{1−(a+b3+b4+c)}≤0.030 is preferably satisfied.

A range of a substitution content of Fe with X1 and/or X2 may be set to be equal to or less than approximately the half of Fe on the basis of the number of atoms. That is, 0≤α+β≤0.50 may be set.

Furthermore, the soft magnetic alloy of this embodiment may contain elements other than the above-described elements as unavoidable impurities. For example, the unavoidable impurities may be respectively included in an amount of 0.1 wt % or less with respect to 100 wt % of soft magnetic alloy.

In addition, the soft magnetic alloy of this embodiment may have a structure including an Fe-based nanocrystal.

Here, the Fe-based nanocrystal represents a crystal which has a nano-order grain size, and in which a crystal structure of Fe is a body centered cubic structure (bcc). In this embodiment, it is preferable to precipitate Fe-based nanocrystal having an average grain size of 5 to 30 nm.

In addition, in a case where the soft magnetic alloy composed of an amorphous material is subjected to a heat treatment, the Fe-based nanocrystal is likely to precipitate in the soft magnetic alloy. In other words, the soft magnetic alloy that has the above-described composition and is composed of an amorphous material is easy to be set as a raw material of the soft magnetic alloy of this embodiment which has the structure including the Fe-based nanocrystal.

In addition, the soft magnetic alloy before the heat treatment may have a structure composed of only the amorphous material, or may have a nanohetero structure in which microcrystals exist in the amorphous material. Note that, the microcrystals may have an average grain size of 0.3 to 10 nm.

Hereinafter, an amorphization rate of the soft magnetic alloy will be described.

In a case where the soft magnetic alloy according to this embodiment is bulk as described later, it is assumed that a soft magnetic alloy in which an amorphization rate X expressed by the following Expression (1) is 85% or more has a structure constituted by an amorphous material, and a soft magnetic alloy in which the amorphization rate X is less than 85% has a structure constituted by crystals.

X=100−(Ic/(Ic+Ia)×100) (1)

Ic: Crystalline scattering integrated intensity

Ia: Amorphous scattering integrated intensity

With regard to the amorphization rate X, crystal structure analysis for a soft magnetic alloy is performed by XRD, identification of a phase is performed, peaks (Ic: crystalline scattering integrated intensity, Ia: amorphous scattering integrated intensity) of crystallized Fe or a compound are read, a crystallization rate is calculated from the peak intensities, and then the amorphization rate X is calculated by the following Expression (1). Hereinafter, a calculation method will be described in more detail.

Crystal structure analysis with XRD is performed for the soft magnetic alloy according to this embodiment to obtain a chart illustrated in FIG. 6. Profile fitting is performed by using a Lorenz function in the following Expression (2) to obtain a crystal component pattern α_{c} representing the crystalline scattering integrated intensity, an amorphous component pattern αₐ representing the amorphous scattering integrated intensity, and a pattern α_{c+a} obtained by combining the patterns as illustrated in FIG. 7. The amorphization rate X is obtained by Expression (1) from the crystalline scattering integrated intensity and the amorphous scattering integrated intensity of the obtained pattern. Note that, a measurement range is set to a range of a diffraction angle 2θ=30° to 60° at which an amorphous material-derived halo can be confirmed. In this range, an error between an integrated intensity that is actually measured with XRD and an integrated intensity calculated by using a Lorenz function is set within 1%.

$$\begin{matrix}[ Formula 1 ] & \\ f ( x ) = \frac{h}{1 + \frac{{( x - u )}^{2}}{{w}^{2}}} + b & ( 2 )\end{matrix}$$

h: peak height
u: peak position
w: full width at half maximum
b: background height

In a case where the soft magnetic alloy according to this embodiment is a thin film to be described later, crystal structure analysis with XRD may be performed by using a method of In-Plane diffraction measurement. In this case, a similar chart as in the case of performing the crystal structure analysis with XRD for bulk by using a typical method is obtained. When performing similar analysis for the chart of the thin film as in analysis performed for the chart of bulk, the amorphization rate X can be calculated.

A shape of the soft magnetic alloy of this embodiment is not particularly limited. Examples of the shape include a ribbon shape, a powder shape, and a thin film shape.

In the following description, the soft magnetic alloy having the ribbon shape and the soft magnetic alloy having the powder shape may be collectively referred to as “bulk”. Furthermore, the soft magnetic alloy having the thin film shape may be referred to as a soft magnetic alloy thin film or a thin film in an abbreviation manner, the soft magnetic alloy having the ribbon shape may be referred to as a soft magnetic alloy ribbon or a ribbon in an abbreviation manner, and the soft magnetic alloy having the powder shape may be referred to as a soft magnetic alloy powder or a powder in an abbreviation manner.

Hereinafter, a method of manufacturing the soft magnetic alloy according to this embodiment will be described, but the method of manufacturing the soft magnetic alloy according to this embodiment is not limited to the following method.

As an example of the method of manufacturing the soft magnetic alloy ribbon according to this embodiment, a method of manufacturing the soft magnetic alloy ribbon with a single roll method is exemplified. In addition, the ribbon may be a continuous ribbon.

In the single roll method, first, pure metals of respective metal elements included in a finally obtained soft magnetic alloy ribbon are prepared, and are weighed to have the same composition as in the finally obtained soft magnetic alloy ribbon. Then, the pure metals of the metal elements are melted and mixed to prepare a mother alloy. Note that, a method of melting the pure metals is arbitrary, and examples thereof include a method in which the pure metals are evacuated in a chamber and are melted with high frequency heating. Note that, typically, the mother alloy has the same composition as in the finally obtained soft magnetic alloy ribbon.

Next, the prepared mother alloy is heated and melted to obtain a molten metal. A temperature of the molten metal is not particularly limited. For example, the temperature may be set to 1200° C. to 1500° C.

In this embodiment, a temperature of the roll is not particularly limited. For example, the temperature may be set to room temperature to 90° C. In addition, a differential pressure (injection pressure) between the inside of the chamber and the inside of a spraying nozzle is not particularly limited. For example, the differential pressure may be set to 20 to 80 kPa.

In the single roll method, the thickness of a ribbon to be obtained can be adjusted mainly by adjusting a rotation speed of the roll. For example, the thickness of the ribbon to be obtained can also be adjusted by adjusting an interval between the nozzle and the roll, the temperature of the molten metal, or the like. The thickness of the ribbon is not particularly limited. For example, the thickness is 10 to 80 μm.

A soft magnetic alloy ribbon before a heat treatment to be described later does not include a crystal having a grain size more than 30 nm. The soft magnetic alloy ribbon before the heat treatment may have a structure composed of only an amorphous material, or a nanohetero structure in which microcrystals exist in the amorphous material. In addition, the amorphization rate X may be 85% or more.

Note that, a method of confirming whether or not crystals having a grain size more than 30 nm are included in the ribbon is not particularly limited. For example, presence or absence of crystals having a grain size more than 30 nm can be confirmed by typical X-ray diffraction measurement.

In addition, a method of observing presence or absence of the microcrystals and an average grain size is not particularly limited. For example, confirmation can be made by obtaining a selected area electron diffraction image, a nanobeam diffraction image, a bright field image, or a high-resolution image by using a transmission electron microscope with respect to a sample sliced by ion milling. In a case of using the selected area electron diffraction image or the nanobeam diffraction image is used, ring-shaped diffraction is formed when a diffraction pattern is amorphous, whereas a diffraction spot due to a crystal structure is formed when the diffraction pattern is not amorphous. In addition, in a case of using the bright field image or the high-resolution image, presence or absence of initial microcrystals and an average grain size can be observed by visual observation at a magnification of 1.00×10⁵ to 3.00×10⁵ times.

Hereinafter, a method of manufacturing the soft magnetic alloy ribbon according to this embodiment by subjecting the soft magnetic alloy ribbon to a heat treatment will be described.

To manufacture a soft magnetic alloy ribbon in which each coefficient of determination is within a predetermined range, particularly, heat treatment conditions are controlled. Preferably, a temperature-raising rate in the heat treatment is set to a fast rate of 100° C./min or more, a retention temperature after temperature-raising is set to 450° C. to 650° C., and retention time is set to a short time of 0.1 to 5 minutes. In addition, a temperature-lowering rate after retention is set to 50 to 1000° C./min. When performing control in this manner, a coefficient of determination between an atomic concentration of Fe and an atomic concentration of at least one of metalloid element is likely to be set to 0.700 or more. Also, a coefficient of determination between the atomic concentration of Fe and an atomic concentration of at least one of M element is likely to be set to 0.700 or more. Furthermore, it is possible to manufacture a soft magnetic alloy ribbon in which a local variation of M or Z exists in a specific range, and each coefficient of determination is within a predetermined range.

An atmosphere in the heat treatment is not particularly limited. The heat treatment may be performed under an active atmosphere such as in the air, under an inert atmosphere such as in an Ar gas, or in vacuo.

In addition, a method of calculating an average grain size in a case where Fe-based nanocrystals are included in the soft magnetic alloy ribbon obtained by the heat treatment is not particularly limited. For example, the average grain size can be calculated through observation by using a transmission electron microscope. In addition, a method of confirming that a crystal structure is a body centered cubic structure (bcc) is also not particularly limited. For example, confirmation can be made by using X-ray diffraction measurement.

As an example of a method of manufacturing the soft magnetic alloy powder according to this embodiment, a method of manufacturing a soft magnetic alloy powder by a gas atomization method.

In the gas atomization method, first, pure metals of respective metal elements included in a finally obtained soft magnetic alloy are prepared, and are weighed to have the same composition as in the finally obtained soft magnetic alloy. Then, the pure metals of the metal elements are melted and mixed to prepare a mother alloy. Note that, a method of melting the pure metals are not particularly limited, and examples thereof include a method in which the pure metals are evacuated in a chamber and are melted with high frequency heating. Note that, typically, the mother alloy has the same composition as in the finally obtained soft magnetic alloy.

Next, the prepared mother alloy is heated and melted to obtain a molten metal. A temperature of the molten metal is not particularly limited. For example, the temperature may be set to 1200° C. to 1500° C. Then, the molten alloy is sprayed with a gas atomization device to prepare a powder.

A particle size of the soft magnetic alloy powder can be preferably controlled by controlling spraying conditions at this time.

The particle size of the soft magnetic alloy powder is not particularly limited. For example, D50 is 1 to 150 μm. Note that, in a case where the soft magnetic alloy powder has a structure composed of Fe-based nanocrystals, a plurality of Fe-based nanocrystals is typically included in one particle of the soft magnetic alloy powder. Accordingly, the particle size of the soft magnetic alloy powder and a grain size of the Fe-based nanocrystals are different from each other.

Appropriate spraying conditions are different also depending on a composition of the molten metal or a target particle size. For example, a nozzle diameter is 0.5 to 3 mm, a molten metal discharging amount is 1.5 kg/min or less, and a gas pressure is 5 to 10 MPa.

The soft magnetic alloy powder before a heat treatment is obtained by the above-described method. To preferably control a crystallite diameter, it is preferable that the soft magnetic alloy powder has an amorphous structure at this point of time.

Hereinafter, a method of manufacturing the soft magnetic alloy powder according to this embodiment by subjecting the soft magnetic alloy powder to a heat treatment will be described.

To manufacture a soft magnetic alloy powder having a microstructure shown in FIG. 3, that is, a soft magnetic alloy powder that includes the α-Fe phase 11 composed of crystals and the amorphous phase 13 but does not include the M-Z compound, particularly, heat treatment conditions are controlled. Preferably, a temperature-raising rate in the heat treatment is set to a fast rate of 100° C./min or more, a retention temperature after temperature-raising is set to 450° C. to 650° C., and retention time is set to a short time of 0.1 to 3 minutes. In addition, a temperature-lowering rate after retention is set to 50 to 1000° C./min. When performing control in this manner, a coefficient of determination between an atomic concentration of Fe and an atomic concentration of at least one of metalloid element is likely to be set to 0.700 or more. A coefficient of determination between the atomic concentration of Fe and an atomic concentration of at least one of M element is likely to be set to 0.700 or more. Furthermore, it is possible to manufacture a soft magnetic alloy ribbon in which a local variation of M or Z exists in a specific range, and each coefficient of determination is within a predetermined range.

An atmosphere in the heat treatment is not particularly limited. The heat treatment may be performed under an active atmosphere such as in the air, under an inert atmosphere such as in a N₂ gas in an Ar gas, or in vacuo.

A method of forming a thin film is not particularly limited. For example, a thin film can be formed by a sputtering method or a vapor deposition method. Hereinafter, a case of forming a thin film by the sputtering method will be described.

Film formation may be carried out simultaneously with multi-target sputtering by using a plurality of kinds of targets, or with single-target sputtering while appropriately changing a target. Simultaneous film formation with the multi-target sputtering is preferable because a bulk crystal state reproducing thin film can be easily manufactured.

A temperature of a substrate during film formation is not particularly limited. For example, the temperature may be set to 25° C. to 350° C.

The kind of the substrate is not particularly limited. For example, a thermal silicon oxide substrate, a silicon substrate, a glass substrate, a ceramic substrate, or a resin substrate can be used. Examples of the ceramic substrate include a barium titanate substrate and an ALTIC substrate. In addition, cleaning may be appropriately performed before performing sputtering.

A film thickness of the thin film is not particularly limited. For example, the film thickness may be set to 50 nm to 50 μm. Furthermore, the thin film may be set as a multilayer film in which films composed of an insulating material and/or high-resistance material are alternately stacked. The kind of the insulating material and/or the high-resistance material is not particularly limited, and examples thereof include SiO₂, Al₂O₃, AlN, and the like. In addition, specific resistance of the insulating material and/or the high-resistance material is 1000 μΩ·cm or more.

Hereinafter, a method of manufacturing the soft magnetic alloy thin film according to this embodiment by subjecting the soft magnetic alloy thin film to a heat treatment will be described.

To manufacture a soft magnetic alloy thin film having the microstructure shown in FIG. 3, that is, a soft magnetic alloy thin film that includes the α-Fe phase 11 composed of crystals and the amorphous phase 13 but does not include the M-Z compound, particularly, heat treatment conditions are controlled. Preferably, a temperature-raising rate in the heat treatment is set to a fast rate of 100° C./min or more, a retention temperature after temperature-raising is set to 450′C to 650° C., and retention time is set to a short time of 0.1 to 5 minutes. In addition, a temperature-lowering rate after retention is set to 50 to 1000° C./min. When performing control in this manner, a coefficient of determination between an atomic concentration of Fe, and an atomic concentration of at least one of metalloid element is likely to be set to 0.700 or more. A coefficient of determination between the atomic concentration of Fe and an atomic concentration of at least one of M element is likely to be set to 0.700 or more. Furthermore, it is possible to manufacture a soft magnetic alloy ribbon in which a local variation of M or Z exists in a specific range, and each coefficient of determination is within a predetermined range.

An atmosphere in the heat treatment is not particularly limited. The heat treatment may be performed under an active atmosphere such as in the air, under an inert atmosphere such as in an N₂ gas in an Ar gas, or in vacuo.

An application of the soft magnetic alloy according to this embodiment is not particularly limited. Examples of the application include a core, an inductor, a transformer, a motor, and the like in the case of the soft magnetic alloy ribbon. A dust core can be exemplified in the case of the soft magnetic alloy powder. Particularly, the soft magnetic alloy can be preferably used as a dust core for an inductor, particularly, a power inductor. In addition, the soft magnetic alloy can be preferably used also in a magnetic component using the soft magnetic alloy thin film, for example, a thin film inductor and a magnetic head.

The soft magnetic alloy according to this embodiment can be set, for example, as a soft magnetic alloy having a higher saturation magnetic flux density Bs in comparison to a known Fe—Si—B—Nb—Cu based soft magnetic alloy. In addition, the soft magnetic alloy according to this embodiment can be set as a soft magnetic alloy having lower coercivity He in comparison to an Fe—Nb—B based soft magnetic alloy that is known to have higher saturation magnetic flux density Bs in comparison to the Fe—Si—B—Nb—Cu based soft magnetic alloy. Furthermore, it is easy to set the soft magnetic alloy according to this embodiment to have a higher saturation magnetic flux density Bs in comparison to the Fe—Nb—B based soft magnetic alloy. That is, a magnetic component using the soft magnetic alloy according to this embodiment is likely to accomplish an improvement in DC superimposing characteristics, a reduction in a core loss, and an increase in inductance, for example, in the case of the inductor. That is, when using the soft magnetic alloy according to this embodiment, it is easy to easy obtain a magnetic component in which a reduction in size, a reduction in power consumption, and high efficiency are accomplished in comparison to a case of using a known Fe—Si—B—Nb—Cu based soft magnetic alloy or a known Fe—Ni—B based soft magnetic alloy. Furthermore, in a case of using the magnetic component such as a transformer using the soft magnetic alloy according to this embodiment in a power supply circuit, it is easy to accomplish an improvement in power supply efficiency due to a reduction in energy loss.

### EXAMPLES

Hereinafter, the present invention will be described in more detail on the basis of examples, but the present invention is not limited to the examples.

### Experimental Example 1

In Experimental Example 1, soft magnetic alloy thin films described in Table 1A and Table 1B were manufactured. Hereinafter, a method of manufacturing a thin film-shaped soft magnetic alloy will be described. Note that, there are some blanks in each table to be described below. This indicates that numerical values which fit the blanks are not calculated.

First, thin films having compositions described in Table 1A and Table 1B were formed by a sputtering method. Film formation was performed by using a magnetron sputter (ES340 manufactured by Eicoh Co., Ltd.). In addition, film formation was performed through simultaneous film formation with a multi-target sputtering by using a plurality of kinds of targets.

In this experimental example, a plurality of thin films was formed in a state in which a temperature of a substrate during film formation was set to 250° C. In addition, the substrate was set as a substrate obtained by cutting a thermal silicon oxide substrate into 6 mm×6 mm, and by subjecting the substate to ultrasonic cleaning by using a solvent in the order of water, acetone, and IPA. The film thickness of the thin film was set to 100 nm. In addition, a gas flow rate inside a chamber was set to 20 sccm, and a gas pressure inside the chamber was set to 0.4 Pa.

The amorphization rate X was measured for each thin film before a heat treatment to be described later by using XRD. It was confirmed that the thin film before the heat treatment has the amorphization rate X of 85% or more in all examples and comparative examples to be described later. Furthermore, presence or absence of microcrystals was confirmed by observing a selected area electron diffraction image and a bright field image in a magnification of 300000 times by using a transmission electron microscope. As a result, it was confirmed that thin films before the heat treatment do not include microcrystals in all examples and comparative examples to be described later.

Next, a heat treatment was performed for each of the thin films. The heat treatment was performed as follows. A temperature was raised to a predetermined retention temperature at a predetermined temperature-raising rate, and the thin film was retained at the predetermined retention temperature for predetermined retention time. The temperature-raising rate, the retention temperature, the retention time, and a temperature-lowering rate after the heat treatment in each thin film are shown in Table 1A and Table 1B. An atmosphere during the heat treatment was set to “in vacuo”.

The coercivity He and the saturation magnetic flux density Bs of each thin film after the heat treatment were measured. The low coercivity He and the saturation magnetic flux density Bs were measured at a maximum application magnetic field of 1000 Oe by using a vibrating sample magnetometer (VSM). Note that, Bs and He of the thin film vary depending on a composition, but with regard to Bs, 1.40 T or more was set as satisfactory and 1.50 T or more set as further satisfactory. With regard to He, 10.0 Oe or less was set as satisfactory, and 5.0 Oe or less was set as further satisfactory.

Presence or absence of α-Fe and presence or absence of the M-Z compound were confirmed for the thin film after the heat treatment by using XRD. Specifically, in an XRD chart, presence or absence of a peak of α-Fe and presence or absence of a peak of the M-Z compound were investigated. In XRD charts in all examples shown in Table 1A and Table 1B, the peak of α-Fe was observed, and the peak of the M-Z compound was not observed.

Each coefficient of determination was measured for the thin film after the heat treatment by using the 3DAP. Specifically, measurement was performed by setting a rectangular parallelepiped having side lengths of 40 nm×40 nm×50 nm as a measurement range. The rectangular parallelepiped (measurement range) was virtually divided into 10000 continuous grids having a cubic shape of 2 nm×2 nm×2 nm by analyzing measurement data obtained by using software. The 10000 grids individually having composition information were statistically dealt and analyzed to calculate a concentration of each element. Then, coefficients of determination R²(Fe—Z1), R²(Fe—Z2), and R²(Fe-M) were derived. In Table 1A, only R²(Fe—C) is described. In all comparative examples described in Table 1A, it was confirmed that not only R²(Fe—C) but also a coefficient of determination between Fe and a metalloid element other than C is less than 0.700.

Furthermore, in all of the examples and comparative examples described in Table 1A, an average of M/C in a region (second region) where a total concentration of Fe, Co, and Ni is 80 at % or less was measured. Specifically, measurement was performed by setting a rectangular parallelepiped having side lengths of 40 nm×40 nm×50 nm as a measurement range. The rectangular parallelepiped (measurement range) was virtually divided into 80000 continuous grids having a cubic shape of 1 nm×1 nm×1 nm by analyzing measurement data obtained by using software. The 80000 grids individually having composition information were statistically dealt and analyzed to calculate a concentration of each element in each grid. Then, among the 80000 grids, grids in which the total concentration of Fe, Co, and Ni is 80 at % or less were extracted. M/C of the extracted grids was calculated and averaged to obtain an average of M/C. Results are shown in Table 1A. Note that, when mapping a part of the measurement results on a plane, mapping images as illustrated in FIG. 8 to FIG. 10 were obtained.

Furthermore, in soft magnetic alloys (thin films, ribbons, and powders) of respective experimental examples described below, it was confirmed that the first region where the total concentration of Fe. Co, and Ni is 85 at % or more is included with the 3DAP unless otherwise stated. Specifically, it was confirmed that grids in which the total concentration of Fe, Co, and Ni is 85 at % or more are included in the 80000 grids having dimensions of 1 nm×1 nm×1 nm. Furthermore, measurement using the 3DAP was carried three times for one sample. Furthermore, in the soft magnetic alloys (thin films, ribbons, and powders) of the respective experimental examples described below, it was confirmed that a volume ratio of the first region in the soft magnetic alloy is 5 to 90 vol %, and a volume ratio of the second region is 10 to 90 vol % unless otherwise stated.

In the respective experimental examples described below, α-Fe and an amorphous material were mixed in the soft magnetic alloys (thin films, ribbons, and powders) after the heat treatment unless otherwise stated. In addition, the M-C compound was not included. In addition, it was confirmed that α-Fe an Fe-based nanocrystal in which an average grain size is 5 to 30 nm and a crystal structure is bcc through observation using XRD and a transmission electron microscope.

In addition, in the respective experimental examples described below, it was confirmed with ICP analysis that compositions of the soft magnetic alloys (thin films, ribbons, and powders) do not vary before and after the heat treatment unless otherwise stated.

TABLE 1A

| | Examples/ | | | | | | | | | | | |
|---|---|---|---|---|---|---|---|---|---|---|---|---|
| | Compar- | | Composition | Temperature- | Retention | Rentention | Temperature- | | | | | XRD |
| Sample | ative | | ( [symbol] of number | raising rate | temperature | time | lowering rate | [symbol] | [symbol] | R²/ | Average | after heat |
| Nos. | Examples | Shape | of atoms) | (° C./min) | (° C.) | (min) | (° C./min) | ( [symbol] ) | ( [symbol] ) | (Fe—C) | of M/C | treatment |
| 1 | Example | [symbol] | [symbol] | [symbol] | [symbol] | [symbol] | [symbol] | [symbol] | [symbol] | [symbol] | [symbol] | [symbol] |
| 2 | Example | [symbol] | [symbol] | [symbol] | [symbol] | [symbol] | [symbol] | [symbol] | [symbol] | [symbol] | [symbol] | [symbol] |
| 3 | Compar- | [symbol] | [symbol] | [symbol] | [symbol] | [symbol] | [symbol] | [symbol] | [symbol] | [symbol] | [symbol] | [symbol] |
| | ative | | | | | | | | | | | |
| | Example | | | | | | | | | | | |
| 4 | Example | [symbol] | [symbol] | [symbol] | [symbol] | [symbol] | [symbol] | [symbol] | [symbol] | [symbol] | [symbol] | [symbol] |
| 5 | Example | [symbol] | [symbol] | [symbol] | [symbol] | [symbol] | [symbol] | [symbol] | [symbol] | [symbol] | [symbol] | [symbol] |
| 6 | Example | [symbol] | [symbol] | [symbol] | [symbol] | [symbol] | [symbol] | [symbol] | [symbol] | [symbol] | [symbol] | [symbol] |
| 7 | Example | [symbol] | [symbol] | [symbol] | [symbol] | [symbol] | [symbol] | [symbol] | [symbol] | [symbol] | [symbol] | [symbol] |
| 8 | Example | [symbol] | [symbol] | [symbol] | [symbol] | [symbol] | [symbol] | [symbol] | [symbol] | [symbol] | [symbol] | [symbol] |
| 9 | Compar- | [symbol] | [symbol] | [symbol] | [symbol] | [symbol] | [symbol] | [symbol] | [symbol] | [symbol] | [symbol] | [symbol] |
| | ative | | | | | | | | | | | |
| | Example | | | | | | | | | | | |
| 10 | Example | [symbol] | [symbol] | [symbol] | [symbol] | [symbol] | [symbol] | [symbol] | [symbol] | [symbol] | [symbol] | [symbol] |
| 11 | Example | [symbol] | [symbol] | [symbol] | [symbol] | [symbol] | [symbol] | [symbol] | [symbol] | [symbol] | [symbol] | [symbol] |
| 12 | Compar- | [symbol] | [symbol] | [symbol] | [symbol] | [symbol] | [symbol] | [symbol] | [symbol] | [symbol] | [symbol] | [symbol] |
| | ative | | | | | | | | | | | |
| | Example | | | | | | | | | | | |
| 13 | Compar- | [symbol] | [symbol] | [symbol] | [symbol] | [symbol] | [symbol] | [symbol] | [symbol] | [symbol] | [symbol] | [symbol] |
| | ative | | | | | | | | | | | |
| | Example | | | | | | | | | | | |
| 14 | Compar- | [symbol] | [symbol] | [symbol] | [symbol] | [symbol] | [symbol] | [symbol] | [symbol] | [symbol] | [symbol] | [symbol] |
| | ative | | | | | | | | | | | |
| | Example | | | | | | | | | | | |
| 15 | Compar- | [symbol] | [symbol] | [symbol] | [symbol] | [symbol] | [symbol] | [symbol] | [symbol] | [symbol] | [symbol] | [symbol] |
| | ative | | | | | | | | | | | |
| | Example | | | | | | | | | | | |
| 16 | Compar- | [symbol] | [symbol] | [symbol] | [symbol] | [symbol] | [symbol] | [symbol] | [symbol] | [symbol] | [symbol] | [symbol] |
| | ative | | | | | | | | | | | |
| | Example | | | | | | | | | | | |
| 17 | Example | [symbol] | [symbol] | [symbol] | [symbol] | [symbol] | [symbol] | [symbol] | [symbol] | [symbol] | [symbol] | [symbol] |

[symbol]

indicates data missing or illegible when filed

TABLE 1B

| [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|
| 18 | Example | [symbol] | [symbol] | [symbol] | [symbol] | [symbol] | [symbol] | [symbol] | [symbol] | [symbol] | [symbol] | [symbol] | [symbol] |
| 19 | Example | [symbol] | [symbol] | [symbol] | [symbol] | [symbol] | [symbol] | [symbol] | [symbol] | [symbol] | [symbol] | [symbol] | [symbol] |
| 20 | Example | [symbol] | [symbol] | [symbol] | [symbol] | [symbol] | [symbol] | [symbol] | [symbol] | [symbol] | [symbol] | [symbol] | [symbol] |
| 21 | Example | [symbol] | [symbol] | [symbol] | [symbol] | [symbol] | [symbol] | [symbol] | [symbol] | [symbol] | [symbol] | [symbol] | [symbol] |
| 2 | Example | [symbol] | [symbol] | [symbol] | [symbol] | [symbol] | [symbol] | [symbol] | [symbol] | [symbol] | [symbol] | [symbol] | [symbol] |
| 22 | Example | [symbol] | [symbol] | [symbol] | [symbol] | [symbol] | [symbol] | [symbol] | [symbol] | [symbol] | [symbol] | [symbol] | [symbol] |
| 23 | Compar- | [symbol] | [symbol] | [symbol] | [symbol] | [symbol] | [symbol] | [symbol] | [symbol] | [symbol] | [symbol] | [symbol] | [symbol] |
| | ative | | | | | | | | | | | | |
| | Example | | | | | | | | | | | | |
| 24 | Compar- | [symbol] | [symbol] | [symbol] | [symbol] | [symbol] | [symbol] | [symbol] | [symbol] | [symbol] | [symbol] | [symbol] | [symbol] |
| | ative | | | | | | | | | | | | |
| | Example | | | | | | | | | | | | |
| 25 | Example | [symbol] | [symbol] | [symbol] | [symbol] | [symbol] | [symbol] | [symbol] | [symbol] | [symbol] | [symbol] | [symbol] | [symbol] |
| 26 | Example | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

From Table 1A, in respective examples in which the temperature-raising rate is sufficiently fast, the retention temperature is sufficiently low, the retention time is sufficiently short, and the temperature-lowering rate is sufficiently fast, it can be seen that each coefficient to of determination was within a predetermined range. In addition, the average of MC in the second region exceeded 1.0. In contrast, in comparative examples in which the temperature-raising rate is too slow, in comparative examples in which the retention temperature is excessively high, comparative examples in which the retention time is excessively long, and in comparative examples in which the temperature-lowering rate is too slow, a coefficient of determination between Fe and each metalloid element was not equal to or more than 0.700. Furthermore, in Sample numbers 14 to 16 as comparative examples in Table 1A, a peak of the M-C compound (TaC) was not observed in the XRD chart. In addition, satisfactory magnetic characteristics were obtained in the examples, but coercivity was high in the comparative examples. Furthermore, in some comparative examples, the saturation magnetic flux density was also low.

From Table 1B, it can be seen that a coefficient of determination varied depending on compositions in a case where heat treatment conditions are the same as each other. In addition, in examples in which at least one of the coefficients of determination R²(Fe—Z1) and R²(Fe—Z2) are 0.700 or more, satisfactory characteristics were obtained. Furthermore, in Sample Numbers 18 to 21 which are examples in which the coefficient of determination R²(Fe-M) is also 0.700 or more, further satisfactory Bs was obtained in comparison to Sample Numbers 25 and 26 in which R²(Fe-M) is less than 0.700. In contrast, in comparative examples in which any one of the coefficients of determination R²(Fe—Z1) and R²(Fe-Z2) is less than 0.700, Bs and/or He were not satisfactory. Furthermore, in Sample Number 24, the peak of the M-C compound was observed in the XRD chart.

### Experimental Example 2

In Experimental Example 2, thin films were formed by changing a composition in a state in which the heat treatment conditions were fixed, that is, the temperature-raising rate was set to 100° C./min, the retention temperature was set to 500° C., the retention time was set to 1 minute, and the temperature-lowering rate was set to 50° C./min. Results are shown in Table 2 to Table 6. In all samples described in Table 2 to Table 6, the peak of α-Fe was observed and the peak of the M-Z compound was not observed in the XRD chart. Note that, in Table 3 and Table 4, the fourth decimal place of all of b1, b2, and b is rounded off, and thus b1+b2 may not be equal to b.

Each coefficient of determination was measured for the thin films after the heat treatment by using the 3DAP. Specifically, measurement was performed by setting a rectangular parallelepiped having side lengths of 40 nm×40 nm×50 nm as a measurement range. The rectangular parallelepiped (measurement range) was virtually divided into 10000 continuous grids having a cubic shape of 2 nm×2 nm×2 nm by analyzing measurement data obtained by using software. The 10000 grids individually having composition information were statistically dealt and analyzed to calculate a concentration of each element in each grid. Then, coefficients of determination R²(Fe—Z1), R²(Fe—Z2), R²(Fe-M), R²(M-Z1), R²(M-Z2), and R²(Z1-Z2) were derived. In all of the following examples, at least one of the coefficients of determination R²(Fe—Z1) and R²(Fe—Z2) was 0.700 or more, and the coefficient of determination R²(Fe-M) was 0.700 or more. In contrast, in all of the following comparative examples, both the coefficients of determination R²(Fe—Z1) and R²(Fe—Z2) were less than 0.700.

Furthermore, an average of M/C in a region (second region) where a total concentration of Fe, Co, and Ni is 80 at % or less was measured. Specifically, measurement was performed by setting a rectangular parallelepiped having side lengths of 40 nm×40 nm×50 nm as a measurement range. The rectangular parallelepiped (measurement range) was virtually divided into 80000 continuous grids having a cubic shape of 1 nm×1 nm×1 nm by analyzing measurement data obtained by using software. The 80000 grids individually having composition information were statistically dealt and analyzed to calculate a concentration of each element in each grid. Then, among the 80000 grids, grids in which the total concentration of Fe, Co, and Ni is 80 at % or less were extracted. M/C of the extruded grids was calculated and averaged to obtain an average of M/C. Results are shown in Table 2 to Table 6. Note that, when mapping a part of the measurement results on a plane, mapping images as illustrated in FIG. 8 to FIG. 10 were obtained.

TABLE 2

| | | [symbol] | | | | | | | | | |
|---|---|---|---|---|---|---|---|---|---|---|---|
| | | | | | | | | | | He | |
| | Examples/ | | | | | | | | | (Thin | |
| Sample | Comparative | | M1═Ta | Z1═C | Z2═P | Coefficients of determination | | | B [symbol] | film) | Average |
| Nos. | Examples | Fe | a | b1 | b2 | R²(M—Z1) | R²(M—Z2) | R²(Z1—Z2) | (T) | (Oe) | of M/C |
| 27 | Comparative | 0.900 | 0.020 | 0.060 | 0.020 | 0.587 | 0.527 | 0.286 | 1.60 | 18.8 | 0.9 |
| | Example | | | | | | | | | | |
| 28 | Example | 0.890 | 0.030 | 0.060 | 0.020 | 0.662 | 0.470 | 0.252 | 1.75 | 9.2 | 1.1 |
| 29 | Example | 0.870 | 0.050 | 0.060 | 0.020 | — | — | — | 1.78 | 7.1 | 1.2 |
| 30 | Example | 0.850 | 0.070 | 0.060 | 0.020 | 0.708 | 0.372 | 0.242 | 1.81 | 4.4 | 1.3 |
| 18 | Example | 0.830 | 0.090 | 0.060 | 0.020 | 0.721 | 0.359 | 0.226 | 1.81 | 4.1 | 1.4 |
| 31 | Example | 0.800 | 0.120 | 0.060 | 0.020 | 0.729 | 0.398 | 0.228 | 1.74 | 5.5 | 2.1 |
| 32 | Example | 0.780 | 0.140 | 0.060 | 0.020 | 0.726 | 0.443 | 0.233 | 1.63 | 9.6 | 2.5 |
| 33 | Comparative | 0.740 | 0.180 | 0.060 | 0.020 | 0.566 | 0.554 | 0.450 | 1.19 | 42.8 | — |
| | Example | | | | | | | | | | |

[symbol]

indicates data missing or illegible when filed

TABLE 3

| | | [symbol] | | | | | | | | | | |
|---|---|---|---|---|---|---|---|---|---|---|---|---|
| | | | | | | | | | | | He | |
| | Examples/ | | | | | | | | | | (Thin | |
| Sample | Comparative | | M1═Ta | C | P | | Coefficients of determination | | | B [symbol] | film) | Average |
| Nos. | Examples | Fe | a | b1 | b2 | Z(═C [symbol] P) | R²(M—Z1) | R²(M—Z1) | R²(M—Z1) | (T) | (Oe) | of M/C |
| 34 | Example | 0.830 | 0.090 | 0.077 | 0.003 | 0.080 | 0.742 | 0.415 | 0.283 | 1.72 | 6.7 | 1.2 |
| 35 | Example | 0.830 | 0.090 | 0.070 | 0.010 | 0.080 | 0.736 | 0.380 | 0.250 | 1.77 | 4.7 | 1.3 |
| [symbol] 8 | Example | 0.830 | 0.090 | 0.060 | 0.020 | 0.080 | 0.721 | 0.359 | 0.226 | 1.81 | 4.1 | 1.4 |
| 36 | Example | 0.830 | 0.090 | 0.040 | 0.040 | 0.080 | 0.710 | 0.402 | 0.243 | 1.82 | 4.8 | 2.2 |
| 37 | Example | 0.830 | 0.090 | 0.030 | 0.050 | 0.080 | 0.662 | 0.446 | 0.251 | 1.80 | 7.7 | 3.5 |
| 38 | Comparative | 0.830 | 0.090 | 0.020 | 0.060 | 0.080 | 0.588 | 0.511 | 0.259 | 1.63 | 13.6 | — |
| | Example | | | | | | | | | | | |

[symbol]

indicates data missing or illegible when filed

TABLE 4

| | | [symbol] | | | | | | | | | | |
|---|---|---|---|---|---|---|---|---|---|---|---|---|
| | | | | | | | | | | | He | |
| | Examples/ | | | | | | | | | | (Thin | |
| Sample | Comparative | | M1═Ta | Z1═C | Z2═P | Z(═Z1 [symbol] Z2) | Coefficients of determination | | | [symbol] | film) | Average |
| Nos. | Examples | Fe | a | b1 | b2 | b (═Z1 [symbol] Z2 | R²(M—Z1) | R²(M—Z2) | R²(Z1—Z2) | (T) | (Oe) | of M/C |
| 39 | Comparative | 0.890 | 0.090 | 0.015 | 0.005 | 0.020 | 0.592 | 0.508 | 0.259 | 1.66 | 13.2 | — |
| | Example | | | | | | | | | | | |
| 40 | Example | 0.880 | 0.090 | 0.023 | 0.008 | 0.030 | 0.698 | 0.476 | 0.243 | 1.72 | 9.2 | 2.8 |
| 41 | Example | 0.860 | 0.090 | 0.038 | 0.013 | 0.050 | 0.713 | 0.412 | 0.237 | 1.77 | 5.0 | 1.8 |
| 42 | Example | 0.850 | 0.090 | 0.040 | 0.020 | 0.060 | 0.715 | 0.420 | 0.235 | 1.76 | 5.0 | 1.7 |
| 18 | Example | 0.830 | 0.090 | 0.060 | 0.020 | 0.080 | 0.721 | 0.359 | 0.266 | 1.81 | 4.1 | 1.4 |
| 43 | Example | 0.810 | 0.090 | 0.080 | 0.020 | 0.100 | 0.722 | 0.330 | 0.214 | 1.77 | 3.8 | 1.5 |
| 44 | Example | 0.790 | 0.090 | 0.090 | 0.030 | 0.120 | 0.724 | 0.325 | 0.211 | 1.75 | 3.1 | 1.5 |
| 45 | Example | 0.790 | 0.090 | 0.100 | 0.020 | 0.120 | 0.720 | 0.315 | 0.213 | 1.73 | 3.6 | 1.5 |
| 46 | Example | 0.750 | 0.090 | 0.120 | 0.040 | 0.160 | 0.719 | 0.308 | 0.220 | 1.66 | 2.9 | — |

[symbol]

indicates data missing or illegible when filed

TABLE 5A

| | | [symbol] | | | | | | | | | | | | |
|---|---|---|---|---|---|---|---|---|---|---|---|---|---|---|
| | | | | | | | | | | | | | He | |
| | Examples/ | | | | | | | | | | | | (Thin | |
| Sample | Comparative | | M1 | | Z1 | | Z2 | | Coefficients of determination | | | [symbol] | film) | Average |
| Nos. | Examples | Fe | Kind | a | Kind | b1 | Kind | b2 | R²(M—Z1) | R²(M—Z2) | R²(Z1—Z2) | (T) | (Oe) | of M/C |
| 18 | Example | [symbol] | [symbol] | [symbol] | [symbol] | [symbol] | [symbol] | [symbol] | [symbol] | [symbol] | [symbol] | [symbol] | [symbol] | 1.4 |
| 47 | Example | [symbol] | [symbol] | [symbol] | [symbol] | [symbol] | [symbol] | [symbol] | — | — | — | [symbol] | [symbol] | — |
| 48 | Example | [symbol] | [symbol] | [symbol] | [symbol] | [symbol] | [symbol] | [symbol] | [symbol] | [symbol] | [symbol] | [symbol] | [symbol] | — |
| 49 | Example | [symbol] | [symbol] | [symbol] | [symbol] | [symbol] | [symbol] | [symbol] | — | — | — | [symbol] | [symbol] | — |
| 50 | Example | [symbol] | [symbol] | [symbol] | [symbol] | [symbol] | [symbol] | [symbol] | [symbol] | [symbol] | [symbol] | [symbol] | [symbol] | — |
| 51 | Example | [symbol] | [symbol] | [symbol] | [symbol] | [symbol] | [symbol] | [symbol] | — | — | — | [symbol] | [symbol] | — |
| 52 | Example | [symbol] | [symbol] | [symbol] | [symbol] | [symbol] | [symbol] | [symbol] | [symbol] | [symbol] | [symbol] | [symbol] | [symbol] | — |
| 53 | Example | [symbol] | [symbol] | [symbol] | [symbol] | [symbol] | [symbol] | [symbol] | — | — | — | [symbol] | [symbol] | — |
| 54 | Example | [symbol] | [symbol] | [symbol] | [symbol] | [symbol] | [symbol] | [symbol] | [symbol] | [symbol] | [symbol] | [symbol] | [symbol] | — |
| 55 | Example | [symbol] | [symbol] | [symbol] | [symbol] | [symbol] | [symbol] | [symbol] | [symbol] | [symbol] | [symbol] | [symbol] | [symbol] | — |
| 56 | Example | [symbol] | [symbol] | [symbol] | [symbol] | [symbol] | [symbol] | [symbol] | [symbol] | [symbol] | [symbol] | [symbol] | [symbol] | — |
| 57 | Example | [symbol] | [symbol] | [symbol] | [symbol] | [symbol] | [symbol] | [symbol] | [symbol] | [symbol] | [symbol] | [symbol] | [symbol] | — |
| 58 | Example | [symbol] | [symbol] | [symbol] | [symbol] | [symbol] | [symbol] | [symbol] | [symbol] | [symbol] | [symbol] | [symbol] | [symbol] | — |
| 59 | Example | [symbol] | [symbol] | [symbol] | [symbol] | [symbol] | [symbol] | [symbol] | [symbol] | [symbol] | [symbol] | [symbol] | [symbol] | — |
| 60 | Example | [symbol] | [symbol] | [symbol] | [symbol] | [symbol] | [symbol] | [symbol] | [symbol] | [symbol] | [symbol] | [symbol] | [symbol] | — |
| 61 | Example | [symbol] | [symbol] | [symbol] | [symbol] | [symbol] | [symbol] | [symbol] | [symbol] | [symbol] | [symbol] | [symbol] | [symbol] | 1.5 |
| 62 | Comparative | [symbol] | [symbol] | [symbol] | [symbol] | [symbol] | [symbol] | [symbol] | [symbol] | [symbol] | [symbol] | [symbol] | [symbol] | — |
| | Example | | | | | | | | | | | | | |

[symbol]

indicates data missing or illegible when filed

TABLE 5B

| | | [symbol] | | | | | | | | | | | | |
|---|---|---|---|---|---|---|---|---|---|---|---|---|---|---|
| | | | | | | | | | | | | | He | |
| | Examples/ | | | | | | | | | | | | (Thin | |
| Sample | Comparative | | M1 | | Z1 | | Z2 | | Coefficients of determination | | | [symbol] | film) | Average |
| Nos. | Examples | Fe | Kind | a | Kind | b1 | Kind | b2 | R²(M—Z1) | R²(M—Z2) | R²(Z1—Z2) | (T) | (Oe) | of M/C |
| 18 | Example | [symbol] | [symbol] | [symbol] | [symbol] | [symbol] | [symbol] | [symbol] | [symbol] | [symbol] | [symbol] | [symbol] | [symbol] | 1.4 |
| 63 | Example | [symbol] | [symbol] | [symbol] | [symbol] | [symbol] | [symbol] | [symbol] | [symbol] | [symbol] | [symbol] | [symbol] | [symbol] | 1.5 |
| 64 | Example | [symbol] | [symbol] | [symbol] | [symbol] | [symbol] | [symbol] | [symbol] | [symbol] | [symbol] | [symbol] | [symbol] | [symbol] | 1.5 |
| 65 | Example | [symbol] | [symbol] | [symbol] | [symbol] | [symbol] | [symbol] | [symbol] | [symbol] | [symbol] | [symbol] | [symbol] | [symbol] | 1.4 |
| 66 | Example | [symbol] | [symbol] | [symbol] | [symbol] | [symbol] | [symbol] | [symbol] | [symbol] | [symbol] | [symbol] | [symbol] | [symbol] | 1.5 |
| 67 | Example | [symbol] | [symbol] | [symbol] | [symbol] | [symbol] | [symbol] | [symbol] | [symbol] | [symbol] | [symbol] | [symbol] | [symbol] | 1.5 |
| 68 | Example | [symbol] | [symbol] | [symbol] | [symbol] | [symbol] | [symbol] | [symbol] | [symbol] | [symbol] | [symbol] | [symbol] | [symbol] | 1.4 |
| 61 | Example | [symbol] | [symbol] | [symbol] | [symbol] | [symbol] | [symbol] | [symbol] | [symbol] | [symbol] | [symbol] | [symbol] | [symbol] | 1.5 |

[symbol]

indicates data missing or illegible when filed

TABLE 6

| | | [symbol] | | | | | | | | | | | |
|---|---|---|---|---|---|---|---|---|---|---|---|---|---|
| | | | | | | | | | | | | He | |
| | Examples/ | | | | | | | | | | | (Thin | |
| Sample | Comparative | | M1 | | Z1 | | Cr | Coefficients of determination | | | [symbol] | film) | Average |
| Nos. | Examples | Shape | Kind | [symbol] | Kind | [symbol] | [symbol] | R²(M—Z1) | R²(M—Z1) | R²(Z1—Z2) | (T) | (Oe) | of M/C |
| 18 | Example | Thin film | — | — | — | — | — | [symbol] | [symbol] | [symbol] | [symbol] | [symbol] | [symbol] |
| 69 | Example | Thin film | Co | 0.100 | — | — | — | [symbol] | [symbol] | [symbol] | [symbol] | [symbol] | [symbol] |
| 70 | Example | Thin film | Co | 0.400 | — | — | — | [symbol] | [symbol] | [symbol] | [symbol] | [symbol] | [symbol] |
| 71 | Example | Thin film | Ni | 0.100 | — | — | — | [symbol] | [symbol] | [symbol] | [symbol] | [symbol] | [symbol] |
| 72 | Example | Thin film | Ni | 0.400 | — | — | — | [symbol] | [symbol] | [symbol] | [symbol] | [symbol] | [symbol] |
| 73 | Example | Thin film | — | — | Al | 0.010 | — | [symbol] | [symbol] | [symbol] | [symbol] | [symbol] | [symbol] |
| 74 | Example | Thin film | — | — | Mn | 0.010 | — | [symbol] | [symbol] | [symbol] | [symbol] | [symbol] | [symbol] |
| 75 | Example | Thin film | — | — | Ag | 0.010 | — | [symbol] | [symbol] | [symbol] | [symbol] | [symbol] | [symbol] |
| 76 | Example | Thin film | — | — | Zn | 0.010 | — | [symbol] | [symbol] | [symbol] | [symbol] | [symbol] | [symbol] |
| 77 | Example | Thin film | — | — | Sn | 0.010 | — | [symbol] | [symbol] | [symbol] | [symbol] | [symbol] | [symbol] |
| 78 | Example | Thin film | — | — | [symbol] | 0.010 | — | [symbol] | [symbol] | [symbol] | [symbol] | [symbol] | [symbol] |
| 79 | Example | Thin film | — | — | Sb | 0.010 | — | [symbol] | [symbol] | [symbol] | [symbol] | [symbol] | [symbol] |
| 80 | Example | Thin film | — | — | Cu | 0.010 | — | [symbol] | [symbol] | [symbol] | [symbol] | [symbol] | [symbol] |
| 81 | Example | Thin film | — | — | Bi | 0.010 | — | [symbol] | [symbol] | [symbol] | [symbol] | [symbol] | [symbol] |
| 82 | Example | Thin film | — | — | La | 0.010 | — | [symbol] | [symbol] | [symbol] | [symbol] | [symbol] | [symbol] |
| 83 | Example | Thin film | — | — | Y | 0.010 | — | [symbol] | [symbol] | [symbol] | [symbol] | [symbol] | [symbol] |
| 84 | Example | Thin film | — | — | — | — | 0.003 | — | — | — | [symbol] | [symbol] | [symbol] |
| 85 | Example | Thin film | — | — | — | — | 0.010 | 0.705 | [symbol] | [symbol] | [symbol] | [symbol] | [symbol] |
| 86 | Example | Thin film | — | — | — | — | 0.020 | — | — | — | [symbol] | [symbol] | [symbol] |
| 87 | Example | Thin film | — | — | — | — | 0.030 | [symbol] | [symbol] | [symbol] | [symbol] | [symbol] | [symbol] |

[symbol]

indicates data missing or illegible when filed

Table 2 shows results of respective samples in which the Ta content (a) is changed with respect to Sample Number 18 shown in Table 1B. As described above, in respective examples in which at least one of the coefficients of determination R²(Fe—Z1) and R²(Fe—Z2) is 0.700 or more, Bs and He were satisfactory. Particularly, in examples in which 0.070≤a≤0.090, He further decreases in comparison to examples in which the relationship of 0.070≤a≤0.090 is not satisfied, and becomes 5.0 Oe or less.

Table 3 shows results of respective samples in which the sum (b1+b2=b) of the C content (b1) and the P content (b2) was fixed to 0.080, and b and c were changed with respect to the Sample Number 18 shown in FIG. 11B. As described above, in respective examples in which at least one of the coefficients of determination R²(Fe—Z1) and R²(Fe—Z2) is 0.700 or more, Bs and He were satisfactory. Note that, in Sample Numbers 18, and 34 to 36 shown in Table 3, Z1 is C and Z2 is P. and in Sample Numbers 37 and 38, Z1 is P, and Z2 is C. Particularly, in Examples in which Z1 is C, Z2 is P, and the Z2 content to the Z content is 0.125 to 1.00 in terms of a ratio of the number of atoms, He further decreases in comparison to examples in which Z1 is P and Z2 is C, or examples in which the Z2 content to the Z content is less than 0.125, and becomes 5.0 Oe or less.

Table 4 shows results of respective samples in which the C content and the P content are changed with respect to Sample Number 18 shown in Table 1B. As described above, in respective examples in which at least one of the coefficients of determination R²(Fe—Z1) and R²(Fe—Z2) is 0.700 or more, Bs and He were satisfactory. Particularly, in examples in which 0.050≤b≤0.160, He further decreases in comparison to examples in which the relationship of 0.050≤b≤0.160 is not satisfied, and becomes 5.0 Oe or less.

Table 5A and Table SB show results of respective samples in which the kind of M1, Z1, and Z2 and the contents thereof are changed with respect to Sample Number 18 shown in Table 1B. As described above, in respective examples in which at least one of the coefficients of determination R²(Fe—Z1) and R²(Fe—Z2) is 0.700 or more, Bs and He were satisfactory.

Table 6 shows results of respective samples in which a part of Fe is substituted with X1 or X2 and respective samples including Cr when being compared with Sample Number 18. As described above, in respective examples in which at least one of the coefficients of determination R²(Fe—Z1) and R²(Fe—Z2) is 0.700 or more. Bs and He were satisfactory.

### Experimental Example 3

In Experimental Example 3, soft magnetic alloy ribbons having an Fe-M-Z based composition described in Table 7 were manufactured. Hereinafter, a method of manufacturing a soft magnetic alloy having a ribbon shape will be described.

First, pure metal materials were respectively weighed to obtain a mother alloy having a composition described in Table 7. In addition, the weighed pure metal materials were evacuated in a chamber and were melted with high frequency heating to prepare a mother alloy.

Then, the prepared mother alloy was heated and melted to obtain a metal in a molten state kept at 120° C., and the metal was sprayed to a roll by using a single roll method of rotating the roll at a rotational speed of 15 m/sec to manufacture a ribbon. A material of the roll was set as Cu. A roll temperature was set to 25° C., a differential pressure (injection pressure) between the inside of the chamber and the inside of a spraying nozzle was set to 40 kPa. In addition, a slit width of a slit nozzle was set to 180 mm, a distance from a slit opening to the roll was set to 0.2 mm, and a roll diameter was set to 300 mm. According to this, the thickness of an obtained ribbon was set to 20 μm, a width of the ribbon was set to 5 mm, and a length of the ribbon was set to several tens of meters.

The amorphization rate X was measured for each ribbon before a heat treatment to be described later by using XRD. It was confirmed that the ribbon before the heat treatment has the amorphization rate X of 85% or more in all examples and comparative examples to be described later. Furthermore, presence or absence of microcrystals was confirmed by observing a selected area electron diffraction image and a bright field image in a magnification of 300000 times by using a transmission electron microscope. As a result, it was confirmed that ribbons before the heat treatment do not include microcrystals in all examples and comparative examples to be described later.

Next, a heat treatment was performed for each of the ribbons. As heat treatment conditions, a temperature-raising rate was set to 100° C., a retention temperature was set to 600° C., retention time was set to 1 minute, and a temperature-lowering rate after the heat treatment was set to 50° C./min. Note that, an atmosphere during the heat treatment was set to an inert atmosphere (Ar atmosphere).

The coercivity He and the saturation magnetic flux density Bs of respective ribbons after the heat treatment were measured. The coercivity He was measured by using an He meter. The saturation magnetic flux density Bs was measured at a maximum application magnetic field of 1000 Oe by using a vibrating sample magnetometer (VSM). Note that, Bs and He of the ribbon vary depending on a composition, but with regard to Bs, 1.40 T or more of Bs was set as satisfactory, and 1.50 T or more was set as further satisfactory. With regard to He, 0.25 Oe or less (19.9 A/m or less) was set as satisfactory, and 0.06 Oe or less (4.8 A/m or less) was set as further satisfactory.

Presence or absence of α-Fe and presence or absence of the M-Z compound were confirmed for the ribbon after the heat treatment by using XRD. Specifically, in an XRD chart, presence or absence of a peak of α-Fe and presence or absence of a peak of the M-Z compound were investigated. In XRD charts in all examples shown in Table 7, the peak of α-Fe was observed, and the peak of the M-Z compound was not observed.

Each coefficient of determination was measured for the ribbon after the heat treatment by using the 3DAP. Specifically, measurement was performed by setting a rectangular parallelepiped having side lengths of 40 nm×40 nm×50 nm as a measurement range. The rectangular parallelepiped (measurement range) was virtually divided into 10000 continuous grids having a cubic shape of 2 nm×2 nm×2 nm by analyzing measurement data obtained by using software. The 10000 grids individually having composition information were statistically dealt and analyzed to calculate a concentration of each element in each grid. Then, coefficients of determination R²(Fe—Z1), R²(Fe—Z2), R²(Fe-M), R²(M-Z1), R²(M-Z2), and R²(Z1-Z2) were derived. In all examples described below, at least one of the coefficients of determination R²(Fe—Z1) and R²(Fe—Z2) was 0.700 or more, and the coefficient of determination R²(Fe-M) was also more than 0.700 or more.

Furthermore, an average of M/C in a region (second region) where a total concentration of Fe, Co, and Ni is 80 at % or less was measured. Specifically, measurement was performed by setting a rectangular parallelepiped having side lengths of 40 nm×40 nm×50 nm as a measurement range. The rectangular parallelepiped (measurement range) was virtually divided into 80000 continuous grids having a cubic shape of 1 nm×1 nm×1 nm by analyzing measurement data obtained by using software. The 80000 grids individually having composition information were statistically dealt and analyzed to calculate a concentration of each element in each grid. Then, among the 80000 grids, grids in which the total concentration of Fe, Co, and Ni is 80 at % or less were extracted. M/C of the extracted grids was calculated and averaged to obtain an average of M/C. Results are shown in Table 7.

TABLE 7

| | | [symbol] | | | | | | | | | | |
|---|---|---|---|---|---|---|---|---|---|---|---|---|
| | | | | | | | | | | | He | |
| | Examples/ | | | | | | | | | | (Thin | |
| Sample | Comparative | | X1 | | X2 | | Coefficients of determination | | | [symbol] | film) | Average |
| Nos. | Examples | Shape | Kind | 0.83α | Kind | 0.83β | R²(M—Z1) | R²(M—Z2) | R²(Z1—Z2) | (T) | (Oe) | of M/C |
| 88 | Example | Ribbon | — | — | — | — | 0.741 | 0.327 | 0.205 | 1.85 | 0.02 | 1.4 |
| 89 | Example | Ribbon | — | — | S | 0.010 | 0.733 | 0.361 | 0.211 | 1.82 | 0.03 | 1.5 |
| 90 | Example | Ribbon | — | — | N | 0.010 | 0.728 | 0.356 | 0.203 | 1.82 | 0.03 | 1.5 |
| 91 | Example | Ribbon | — | — | O | 0.010 | 0.722 | 0.388 | 0.210 | 1.81 | 0.06 | 1.4 |
| 92 | Example | Ribbon | — | — | Al | 0.010 | 0.708 | 0.383 | 0.224 | 1.74 | 0.02 | 1.5 |
| 93 | Example | Ribbon | — | — | Ag | 0.010 | 0.719 | 0.391 | 0.218 | 1.78 | 0.02 | 1.5 |
| 94 | Example | Ribbon | — | — | Zn | 0.010 | 0.705 | 0.372 | 0.215 | 1.74 | 0.03 | 1.4 |
| 95 | Example | Ribbon | — | — | Cu | 0.010 | 0.750 | 0.330 | 0.219 | 1.81 | 0.02 | 1.5 |
| 96 | Example | Ribbon | Co | 0.100 | — | — | 0.733 | 0.372 | 0.227 | 1.83 | 0.04 | 1.4 |
| 97 | Example | Ribbon | Ni | 0.100 | — | — | 0.708 | 0.410 | 0.242 | 1.76 | 0.03 | 1.4 |

[symbol]

indicates data missing or illegible when filed

In all of the examples described in Table 7, as described above, at least one of the coefficients of determination R²(Fe—Z1) and R²(Fe—Z2) was 0.700 or more, and satisfactory magnetic characteristics were obtained.

### Experimental Example 4

In Experimental Example 4, a sample having a thin film shape, a sample having a ribbon shape, and a sample having a powder shape were manufactured by changing heat treatment conditions with respect to compositions shown in Table 8. A method of manufacturing the sample having the thin film shape was set to be similar to Experimental Example 1. A method of manufacturing the sample having the ribbon shape was similar to the manufacturing method in Experimental Example 3, but heat treatment conditions were set to conditions described in Table 8. Hereinafter, a method of manufacturing the sample having the powder shape will be described.

First, pure metal materials were respectively weighed to obtain a mother alloy having a composition described in Table 8. In addition, the weighed pure metal materials were evacuated in a chamber and were melted with high frequency heating to prepare a mother alloy.

Then, the prepared mother alloy was heated and melted to obtain a metal in a molten state kept at 1500° C., and the metal was sprayed in a composition shown in Table 8 by using a gas atomization method, thereby preparing a powder. The powder was prepared under conditions in which a nozzle diameter was set to 1 mm, a molten metal discharge amount was set to 1 kg/min, and a gas pressure was set to 7.5 MPa.

The amorphization rate X was measured for each powder before a heat treatment to be described later by using XRD. It was confirmed that the powder before the heat treatment has the amorphization rate X of 85% or more in all examples to be described later. Furthermore, presence or absence of microcrystals was confirmed by observing a selected area electron diffraction image and a bright field image in a magnification of 300000 times by using a transmission electron microscope. As a result, it was confirmed that powders before the heat treatment do not include microcrystals in all examples and comparative examples to be described later.

Next, a heat treatment was performed for each of the powders. Heat treatment conditions are shown in Table 8. Note that, an atmosphere during the heat treatment was set to an inert atmosphere (Ar atmosphere).

The coercivity He and the saturation magnetic flux density Bs of respective powders after the heat treatment were measured. The coercivity He was measured by using an He meter. The saturation magnetic flux density Bs was measured at a maximum application magnetic field of 1000 Oe by using a vibrating sample magnetometer (VSM). Bs and He of the powders vary depending on a composition, but with regard to Bs, 1.40 T or more of Bs was set as satisfactory, and 1.50 T or more was set as further satisfactory. With regard to He, 15.0 Oe or less (1194 A/m or less) was set as satisfactory, and 5.0 Oe or less (398 A/m or less) was set as further satisfactory.

Presence or absence of α-Fe and presence or absence of the M-Z compound were confirmed for the powders after the heat treatment by using XRD. Specifically, in an XRD chart, presence or absence of a peak of α-Fe and presence or absence of a peak of the M-Z compound were investigated. In XRD charts in all examples shown in Table 8, the peak of α-Fe was observed, and the peak of the M-Z compound was not observed. In contrast, in all comparative examples described in Table 8, the peak of α-Fe and a peak of TaC that is a kind of the M-Z compound were observed.

Each coefficient of determination was measured for the powders after the heat treatment by using the 3DAP. Specifically, measurement was performed by setting a rectangular parallelepiped having side lengths of 40 nm×40 nm×50 nm as a measurement range. The rectangular parallelepiped (measurement range) was virtually divided into 10000 continuous grids having a cubic shape of 2 nm×2 nm×2 nm by analyzing measurement data obtained by using software. The 10000 grids individually having composition information were statistically dealt and analyzed to calculate a concentration of each element in each grid. Then, coefficients of determination R²(Fe—Z1), R²(Fe—Z2), R²(Fe-M), R²(M-Z1), R²(M-Z2), and R²(Z1-Z2) were derived. In all examples described below, at least one of the coefficients of determination R²(Fe—Z1) and R²(Fe—Z2) was 0.700 or more, and the coefficient of determination R²(Fe-M) was also more than 0.700 or more. In contrast, in all comparative examples described below, both the coefficients of determination R²(Fe—Z1) and R²(Fe—Z2) were less than 0.700.

Furthermore, an average of M/C in a region (second region) where a total concentration of Fe, Co, and Ni is 80 at % or less was measured with respect to the powders after the heat treatment by using the 3DAP. Specifically, measurement was performed by setting a rectangular parallelepiped having side lengths of 40 nm×40 nm×50 nm as a measurement range. The rectangular parallelepiped (measurement range) was virtually divided into 80000 continuous grids having a cubic shape of 1 nm×1 nm×1 nm by analyzing measurement data obtained by using software. The 80000 grids individually having composition information were statistically dealt and analyzed to calculate a concentration of each element in each grid. Then, among the 80000 grids, grids in which the total concentration of Fe, Co, and Ni is 80 at % or less were extracted, and M/C of the extracted grids was calculated and averaged to obtain an average of MIC. Results are shown in Table 8.

TABLE 8

| | | [symbol] | | | | | | | | | | | | | | | | | | |
|---|---|---|---|---|---|---|---|---|---|---|---|---|---|---|---|---|---|---|---|---|
| | | | [symbol] | [symbol] | [symbol] | [symbol] | [symbol] | [symbol] | [symbol] | [symbol] | [symbol] | | | | | | [symbol] | [symbol] | | |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

From Table 8, even though the shape of the soft magnetic alloy is any of the thin film shape, the ribbon shape, and the powder shape, in respective samples of examples in which the temperature-raising rate was sufficiently fast, and the retention time was sufficiently short, as described above, at least one of the coefficients of determination R²(Fe—Z1) and R²(Fe—Z2) was 0.700 or more. In contrast, in comparative examples in which the temperature-raising rate was too slow, and the retention time was excessively long, the coefficient of determination R²(Z1-Z2) was not within a predetermined range. Furthermore, as described above, both the coefficients of determination R²(Fe—Z1) and R²(Fe—Z2) were less than 0.700. In addition, satisfactory magnetic characteristics were obtained in the examples, but the coercivity was higher in the comparative examples.

### DESCRIPTION OF THE REFERENCE NUMERAL

1 soft magnetic alloy (of this embodiment)
101,201 soft magnetic alloy (of the related art)
11 α-Fe phase
13 amorphous phase
M-Z compound phase (M-C compound phase)

1. A soft magnetic alloy comprising Fe and at least one of metalloid elements,
wherein an amorphous material and a nanocrystal having a grain size of 5 to 30 nm are mixed, and
a coefficient of determination between an atomic concentration of Fe and an atomic concentration of the at least one of metalloid elements is 0.700 or more.

2. The soft magnetic alloy according to claim 1, further comprising:
at least one of M, M being transition metals of Group 4 to Group 6,
wherein a coefficient of determination between the atomic concentration of Fe and an atomic concentration of the at least one of M is 0.700 or more.

3. The soft magnetic alloy according to claim 1,
wherein the soft magnetic alloy has an Fe-M-Z based composition,
M is one or more of transition metals of Group 4 to Group 6, and Z is two or more of C, P, Si, B, and Ge,
an element among Z having the highest content ratio as a ratio of the number of atoms with respect to the entirety of the soft magnetic alloy is set as Z1, and an element among Z having the highest content ratio except Z1 is set as Z2,
a coefficient of determination between an atomic concentration of M and an atomic concentration of Z1 is 0.600 or more, or a coefficient of determination between the atomic concentration of M and an atomic concentration of Z2 is 0.600 or more, and
a coefficient of determination between the atomic concentration of Z1 and the atomic concentration of Z2 is less than 0.400.

4. The soft magnetic alloy according to claim 1,
wherein the soft magnetic alloy has an Fe-M-Z based composition,
M is one or more of transition metals of Group 4 to Group 6, and Z is two or more of C, P, Si, B, and Ge,
an element among Z having the highest content ratio as a ratio of the number of atoms with respect to the entirety of the soft magnetic alloy is set as Z1, and an element among Z having the highest content ratio except Z1 is set as Z2,
a coefficient of determination between an atomic concentration of M and an atomic concentration of Z1 is less than 0.500, or a coefficient of determination between the atomic concentration of M and an atomic concentration of Z2 is less than 0.500, and
a coefficient of determination between the atomic concentration of Z1 and the atomic concentration of Z2 is less than 0.400.

5. The soft magnetic alloy according to claim 4,
wherein the Fe-M-Z based composition is expressed by a compositional formula of (Fe_{(1-(α+β))}X1_{α}X2_{β})_{(1-(a+b+c))}M1ₐZ_{b}Cr_{c},
X1 is one or more of Co and Ni,
X2 is one or more of Al, Mn, Ag, Zn, Sn, Cu, Bi, N, O, S, and a rare-earth element,
M1 is one or more of Ta, V, Zr, Hf, Ti, Nb, Mo, and W,
0.030≤a≤0.140,
0.030≤b≤0.275,
0.000≤c≤0.030,
0≤α(1−(a+b+c))≤0.400,
β≥20, and
0≤α+β≤0.50 are satisfied.

6. The soft magnetic alloy according to claim 5,
wherein 0.050≤b≤0.200 is satisfied.

7. The soft magnetic alloy according to claim 5,
wherein 0.730≤1−(a+b+c)≤0.930 is satisfied.

8. The soft magnetic alloy according to claim 1,
wherein the soft magnetic alloy has an Fe-M-C based composition,
a peak of an M-C compound is not observed in an XRD chart of the soft magnetic alloy, and
the soft magnetic alloy has a first region in which a total concentration of Fe, Co, and Ni is 85 at % or more and a second region in which the total concentration of Fe, Co, and Ni is 80 at % or less, and an average of M/C that is a value obtained by dividing an atomic concentration of M by an atomic concentration of C in the second region is more than 1.0.

9. The soft magnetic alloy according to claim 8,
wherein the Fe-M-C based composition is expressed by a compositional formula of (Fe_{(1-(α+β))}X1_{α}X2_{β})_{(1-(a+b1+b2+c))}M1ₐC_{b3}Z3_{b4}Cr_{c},
X1 is one or more of the group consisting of Co and Ni,
X2 is one or more of the group consisting of Al, Mn, Ag, Zn, Sn, As, Sb, Cu, Bi, N, O, S, and a rare-earth element,
M1 is one or more of the group consisting of Ta, V, Zr, Hf, Ti, Nb, Mo, and W,
Z3 is one or more of the group consisting of P, B, Si, and Ge,
0.030≤a≤0.140,
0.005≤b3≤0.200,
0.000≤b4≤0.180,
0.000≤c≤0.030,
0≤α(1−(a+b3+b4+c))≤0.400,
β≥0, and
0≤α+β≤0.50 are satisfied.

10. The soft magnetic alloy according to claim 9,
wherein 0.040≤b3≤0.120 is satisfied.

11. The soft magnetic alloy according to claim 9,
wherein 0.730≤1−(a+b3+b4+c)≤0.930 is satisfied.

12. The soft magnetic alloy according to claim 5,
wherein 0.050≤a≤0.140 is satisfied.

13. The soft magnetic alloy according to claim 1,
wherein the soft magnetic alloy contains Fe-based nanocrystals.

14. The soft magnetic alloy according claim 1,
wherein the soft magnetic alloy has a ribbon shape.

15. The soft magnetic alloy according to claim 1,
wherein the soft magnetic alloy has a powder shape.

16. The soft magnetic alloy according to claim 1,
wherein the soft magnetic alloy has a thin film shape.

17. A magnetic component comprising the soft magnetic alloy according to claim 1.

18. The soft magnetic alloy according to claim 9,
wherein 0.050≤a≤0.140 is satisfied.
